(19) United States
(12) Patent Application Publication
(10) Pub. No.: US 2011/0036749 A1
(43) Pub. Date: Feb. 17, 2011

(54) STORAGE, TRANSPORT AND DISPLAY SYSTEM

(75) Inventors: Fredrik Jacobsson, Nacka (SE); Andreas Nagel, Fulda (DE)

Correspondence Address: YOUNG & THOMPSON, 209 Madison Street, Suite 500, Alexandria, VA, 22314, US

(73) Assignee: SCA PACKAGING MARKETING NV, Deigem (BE)

(21) Appl. No.: 12/864,590

(22) PCT Filed: Jan. 23, 2009
(86) PCT No.: PCT/SE2009/050071

§ 371 Date: Nov. 4, 2010

(30) Foreign Application Priority Data
Jan. 24, 2008 (SE) PCT/SE2008/050079
Sep. 3, 2008 (SE) PCT/SE2008/050988

(51) Int. Cl. B65D 5/42; A47F 1/04; A47F 7/00; F16M 13/00

(52) U.S. Cl. 206/736; 211/59.2; 248/250

(57) ABSTRACT

A container for storage, transport and dispensing of products. The container is convertible between a first configuration A suitable for storage and transport, and a second configuration B suitable for display. The containers can be interlocked with each other and supported on a support system. A blank for the construction of the container, a support system for the container, and an adaptor for adapting a substantially horizontal shelf to take the containers are also described.

### TECHNICAL FIELD

The present invention relates to a container for storage, transport, display and dispensing of products. It further relates to a blank for forming said container, a support system for said container and an adaptor which makes it possible to use the container of the invention on traditional horizontal shelves. The invention also provides a combination of at least one container and the support system or the adaptor of the invention.

### BACKGROUND OF THE INVENTION

Retailers have always attempted to balance good presentation of a sufficient quantity of products against space restrictions and the risk of taking up space with unsold goods. To this end, so-called “Stock Keeping Units” (SKUs) have been developed which contain and display products at the retail premises.

In addition, it is desirable to combine the storage, transport and display properties of a container or package, such that a single container can fulfil the requirements of each part of the supply chain. For example, containers for storage and transport must be robust enough to tolerate the handling processes thereof, while containers for display must present the products in an attractive manner, at the same time as allowing easy access to the product.

Many advantages are obtained if a single container can be used for storage, transport and display. For example, products do not have to be unloaded individually onto shelves in a store, and the product can be presented and displayed in accordance with the manufacturer's wishes. Using the same container for storage, transport and display can also lead to savings in materials, as one container can be used throughout the supply chain.

It is known to display products such as confectionery on sloping shelves. An advantage of this is that—when the consumer takes the lowermost product—one or more of the remaining products slide down under the influence of gravity and fill the space left by the product which has been removed. In this way, products always lie in the most accessible and visible portion of the shelf.

Sloping shelves can nonetheless present disadvantages. For example, sloping shelves (especially low-lying sloping shelves) are difficult to fill with individual products, as the person filling the shelves has to reach under the above-lying sloping shelf, to the top of the shelf which they are trying to fill. Consequently, the vertical distance between such sloping shelves must be relatively large; often larger than the vertical distance between similar horizontal shelves.

It is also known to place containers of products such as confectionery on sloping shelves. The containers are prevented from slipping off the shelves by a ledge or lip located on the lower edge of the shelf. However, as the ledge is located at the lower edge of the shelf, it often hinders the insertion or removal of containers to or from said shelves. Ledges or lips can also hinder access to the products, especially when only a few products are left in the container. Furthermore, as the front face of such containers are predominantly open, the products in said containers are not restricted from sliding or falling, and will often do so, creating a messy appearance and poor availability to the customer. In addition, such shelves take up just as much space when empty as when filled.

DE 82 30 013 and DE 39 40 801 describe packaging and display containers with hook arrangements which allow them to be hung on racks. JP 2002-002685 discloses similar containers. FR 94 062089 discloses a container which can be assembled with other identical containers.

US 2006/0243683 describes a merchandising display system having a plurality of containers supported on a shelf. WO2004/030497 discloses a display unit consisting of a stand and inserted trays.

GB 2,438,486 discloses a convertible shipping and display container, while GB 1,147,520 discloses a confectionery box.

A display system for chocolate tablets is known from DE 102 40 346. The display comprises an array of interlocking containers, in which containers are stacked upon one another (i.e. the display is built solely of containers, and no separate support means is present). Each container comprises two stacks of chocolate tablets arranged side-by-side, and each container contains only one type of chocolate. A typical display comprises containers of different type of chocolate arranged in the display as required by the retailer, e.g. to form a pattern. One disadvantage with the above system is that, should a container in the lower portion of the display become empty, it is impossible to remove it and replace it with a fresh container without removing all overlying containers. Accordingly, to save time and man-hours associated with replacing individual containers, containers in the display often remain empty until the entire display is disassembled. In addition, the system of DE 102 40 346 is not flexible, and containers cannot be removed or moved about the display at will without disassembling large portions of—or sometimes all of—the display.

There is a need for a space-efficient system for storage, transport and display of products, in which the advantages of sloping shelves are combined with features which allow efficient filling of products. A highly flexible display system is also advantageous. The system should also allow easy, controllable dispensing (e.g. without unwanted products falling out) and—if the customer changes their mind about a purchase—allow products to be replaced in the system. It is also advantageous that products are presented as far forwards as possible, and that the edge of the system which lies closest to the user (the front edge) is always filled with product. Another problem addressed by the present invention is to provide unhindered access to the products, especially when only a few products remain in the container. Containers which are “shelf-ready” are also useful, as the same container can be used for transport, storage, display and dispensing of the product.

Other advantages of the invention will become evident from the following description text.

### SUMMARY OF THE INVENTION

Accordingly, the present invention provides a container for the storage, transport, display and dispensing of products, said container comprising:
opposing top and bottom panels separated by a height H;
at least one sidewall extending between said top and bottom panels,
a dispensing opening located in a portion of a sidewall in the region adjacent to said bottom panel, and optionally extending into a portion of said bottom panel, said dispensing opening having a height H1 in the sidewall which is less than the height H of the container. The container comprises at least one protrusion for selective releasable cooperation with one of a container support system or an identical container, said at least one protrusion being integrally formed with at least one of said top panel, bottom panel or at least one sidewall.

In a first configuration A, said at least one protrusion is accommodated within said at least one of said top panel, bottom panel or at least one sidewall; and, in a second configuration B, said at least one protrusion extends from said at least one sidewall in a direction opposite to said dispensing opening.

The protrusions may be arranged so as to form a portion of one or more sidewalls of the container in the first configuration A and folded out from said sidewalls in the second configuration B.

Suitably, the dispensing opening has an extension H1 in the height H direction which is less than 50%, preferably less than 30% of the total height H of the container. The dispensing opening optionally extends into a portion of said bottom panel. The height H of the container may be at least 1.5 times, preferably at least 2 times, more preferably at least 3 times, the width W and/or the depth D of the container.

Suitably, the container is cuboid and has sidewalls consisting of; opposing rectangular front and rear panels separated by a depth D, and first and second opposing rectangular side panels separated by a width W. The dispensing opening may be located in said front panel, and in the first configuration A, the at least one protrusion extends from the rear panel. The front panel of the container may additionally comprise at least one support opening, such that—when two containers are stacked upon each other in the second configuration B—the at least one protrusion extending from the rear panel of one container engages with the support opening on the front panel of the other container. The rear panel of the container may additionally comprise a viewing opening. Suitably, the at least one protrusion is integrally formed with the rear panel. The protrusion preferably comprises a flap which opens in the direction of the top panel.

The invention also provides a blank for forming a container as described herein. In particular, the blank may comprise:
a first rectangular panel having opposing side edges and opposing end edges, wherein each of said opposing side edges has a length (H) corresponding to the height (H) of the container and each of said opposing end edges has a length (W) corresponding to the width W of the container;
second and third rectangular panels, each having opposing side edges and opposing end edges, wherein each of said opposing side edges has a length (H) corresponding to the height (H) of the container and each of said opposing end edges has a length (D) corresponding to the depth (D) of the container;
a fourth rectangular panel having opposing side edges and opposing end edges, wherein each of said opposing side edges has a length (H) corresponding to the height (H) of the container and each of said opposing end edges has a length (W) corresponding to the width W of the container;
flaps extending from the opposing end edges of at least three of said rectangular panels, said flaps being arranged so as to constitute top and bottom panels of said container;
   wherein the second and third rectangular panels are located on either side of the first rectangular panel such that each of said opposing side edges of the first rectangular panel is joined to one opposing side edge of the second and third rectangular panels and separated therefrom by score lines, and;
   the fourth rectangular panel is located adjacent the second rectangular panel, such that the opposing side edge of the fourth rectangular panel is joined to the other opposing side edge of the second rectangular panel and separated therefrom by score line;
   and wherein the opposing side edge of the fourth rectangular panel which is not joined to the second rectangular panel; or the opposing side edge of the third rectangular panel, comprises a flap for connecting the opposing side edge of the third rectangular panel to the opposing side edge of the fourth rectangular panel,
   and wherein the fourth rectangular panel comprises means for forming a dispensing opening, adjacent to one end edge thereof, and that;
   at least one of the first, second, third or fourth rectangular panels comprises means for forming at least one protrusion.

In the blank according to the invention, the means for forming the dispensing opening suitably has an extension H1 in the height H direction which is less than 50%, preferably less than 30% of the total height H of the container. Optionally, the fourth panel additionally comprises means for forming a support opening, while the first panel optionally comprises means for forming a viewing opening.

The invention also relates to a support system for a container as described herein, said support system comprising at least one frame, said at least one frame comprising: at least one first support means which is adapted to engage with at least one protrusion on the container, thus preventing the container from sliding down in the direction of the bottom panel thereof, and at least one second support means for preventing the container from rotating about an axis perpendicular to the two opposing side panels thereof, thus maintaining said at least one container on said support system such that the panel of the container from which the protrusions extend makes an angle with the horizontal plane of between 10 and 80°. The frames of the support system do not comprise means such as a ledge, protrusion, or lip at the lower edge thereof, which is adapted to contact the bottom panel of the container. The first support means comprises a wire, rod, ledge or thread extending in the horizontal plane.

The at least one first support means is selected from the group consisting of a wire, rod, ledge, thread or cut-out extending in the horizontal plane across substantially the entire frame; which engages with said at least one protrusion on the container. Similarly, the at least one second support means may be selected from the group consisting of a wire, rod, thread, ledge or panel which optionally engages with at least one protrusion on the container.

A particular support system according to the invention is to be used for a container in which the protrusion comprises a flap which opens in the direction of the top panel of the container. The support system comprises at least one shelf having at least a front member and a rear member, said front member arranged to lie between the rear member and the container in use. The front member and rear member together define a space which has a maximum extension which is less than the length of said flap. The rear member comprises an opening for receiving the distal end of the flap. The space and the opening are arranged with respect to each other in the plane of the shelf such that—when mounting a container in said shelf—the flap engages in the space between the front and rear members. When removing a container from said shelf the container is displaced in the plane of the shelf, such that the flap can be inverted in said opening, allowing the container to be withdrawn. Suitably, the shelf is made of one single piece of material which is bent to form the front member and the rear member, respectively.

The invention also provides an adaptor for adapting at least one substantially horizontal shelf so as to be able to support a container as described herein at an angle to the horizontal shelf. The adaptor comprises at least one first support means which is adapted to engage with said at least one protrusion on the container, thus preventing the container from sliding down in the direction of the bottom panel thereof, and at least one second support means for preventing the container from rotating about an axis perpendicular to the two opposing side panels thereof, thus maintaining said at least one container on said adaptor. The at least one container is thus maintained on the adaptor such that the panel of the container from which the protrusions extend makes an angle with the horizontal shelf. The adaptor does not comprise means such as a ledge, protrusion, or lip at the lower edge thereof, which is adapted to contact the bottom panel of the container.

Suitably, the angle between the panel of the container from which the protrusions extend and the horizontal shelf is between 10 and 80°. Alternatively, it may be substantially 90°. The adaptor may further comprise at least one engaging means which is adapted to engage with said shelf. First engaging means may be adapted to engage with the upper surface of the shelf while second engaging means may be adapted to engage with the lower surface of said shelf, with both first and second engaging means being located at the same end of the adaptor. Preferably, the first and second support means are arranged so that said container is supported so that it extends at least partially beyond the front edge of the horizontal shelf.

The invention also provides a system comprising:
a. at least one container as described herein, and
b. a support system as described herein;
   said at least one container being supported on said support system at an angle, by means of said at least one protrusion, with the front panel located above said bottom panel, such that the two side panels are vertical, and the panel of the container from which the protrusions extend makes an angle with the horizontal plane of between 10 and 80°.

Similarly, the invention provides a system comprising:
a. at least one container as described herein, and
b. an adaptor as described herein;
   said at least one container being supported on said adaptor at an angle, by means of said at least one protrusion, with the front panel located above said bottom panel, such that the two side panels are vertical, and the panel of the container from which the protrusions extend makes an angle with the horizontal plane.

### DEFINITIONS

A “protrusion” is defined as a portion of the container which extends from the container's sidewall; i.e. it has an extension in a direction which lies out of the plane of the sidewall.

The terms “vertical” and “horizontal” are used in their usual sense—a component which is aligned with the horizontal plane lies substantially parallel to the ground, and a component which is aligned with the vertical plane lies substantially at right angles to the ground.

### BRIEF DESCRIPTION OF THE DRAWINGS

The invention will now be more closely described by way of example only with reference to the embodiments below and the enclosed Figures, in which.

FIGS. 1A and 1B show a container according to the invention,

FIG. 1C shows the blank used to form the container of FIGS. 1A and B,

FIGS. 2A and 2B show an alternative embodiment of the container according to the invention,

FIG. 2C shows the blank used to form the container of FIGS. 2A and B,

FIGS. 3A and 3B show an alternative embodiment of the container according to the invention,

FIG. 3C shows the blank used to form the container of FIGS. 3A and B,

FIGS. 4A and 4B show an alternative embodiment of the container according to the invention,

FIG. 4C shows the blank used to form the container of FIGS. 4A and B,

FIGS. 5A, 5B and 5C show an alternative embodiment of the container according to the invention,

FIG. 5D shows the blank used to form the container of FIGS. 5A and B,

FIG. 6A shows two containers according to FIG. 2 stacked upon one another and interlocked,

FIG. 6B shows two containers according to FIG. 1 stacked upon one another and interlocked,

FIG. 6C shows two containers according to FIG. 3 stacked upon one another and interlocked,

FIG. 7 shows a support system according to the invention,

FIG. 8 shows the support system filled with containers

FIG. 9 is a side view of the support system of FIG. 7.

FIG. 10 shows an expanded view of a portion of the support system of FIG. 7.

FIG. 11 shows a comparison of the support system of FIG. 9 with a standard shelving system.

FIG. 12A-F show how the container of FIG. 1 can be introduced on, and removed from, a support system.

FIGS. 13, 14 and 15 illustrate alternative embodiments of the specialised support system, in cross-section.

FIG. 16 shows one embodiment of an adaptor according to the invention, in side view and plan view.

FIG. 17 shows a three-dimensional view of the adaptor of FIG. 16.

FIG. 18 shows how the adaptor of FIG. 16 is used to support a container of the invention on a horizontal shelf.

FIG. 19 shows an alternative embodiment of an adaptor according to the invention.

FIG. 20 shows the adaptor of FIG. 19, in combination with a container of the invention.

FIG. 21 shows an alternative embodiment of an adaptor according to the invention.

FIG. 22 shows the adaptor of FIG. 21, in combination with a container of the invention.

FIG. 23 shows an alternative embodiment of an adaptor according to the invention.

FIG. 24 shows the adaptor of FIG. 23, in combination with a container of the invention.

FIG. 25 shows an alternative embodiment of an adaptor according to the invention.

FIG. 26 shows the adaptor of FIG. 25, in combination with a container of the invention.

### DETAILED DESCRIPTION OF PREFERRED EMBODIMENTS

### Container

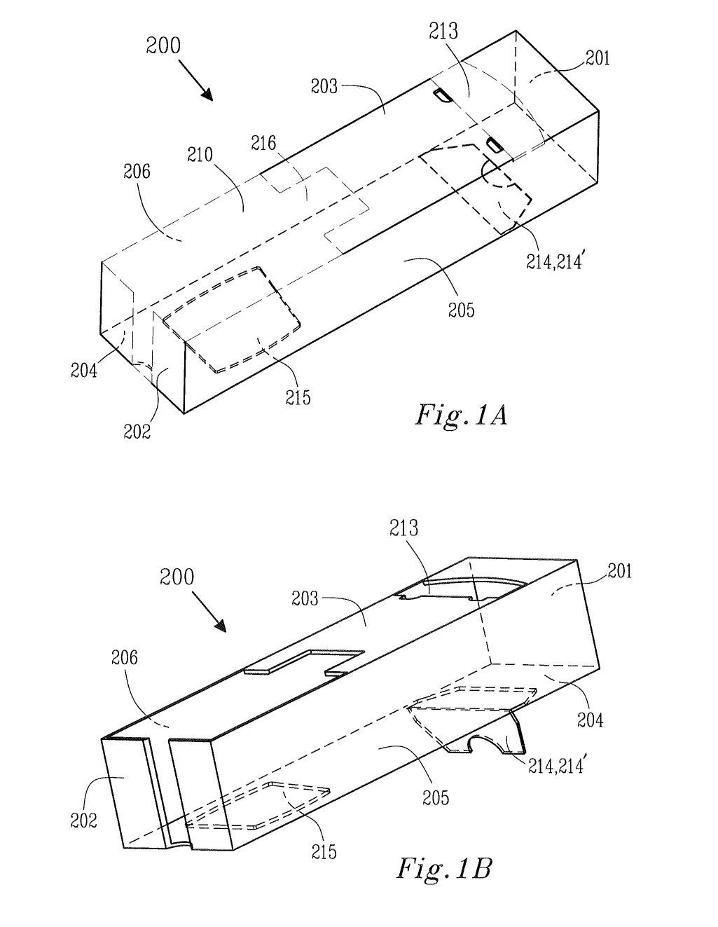

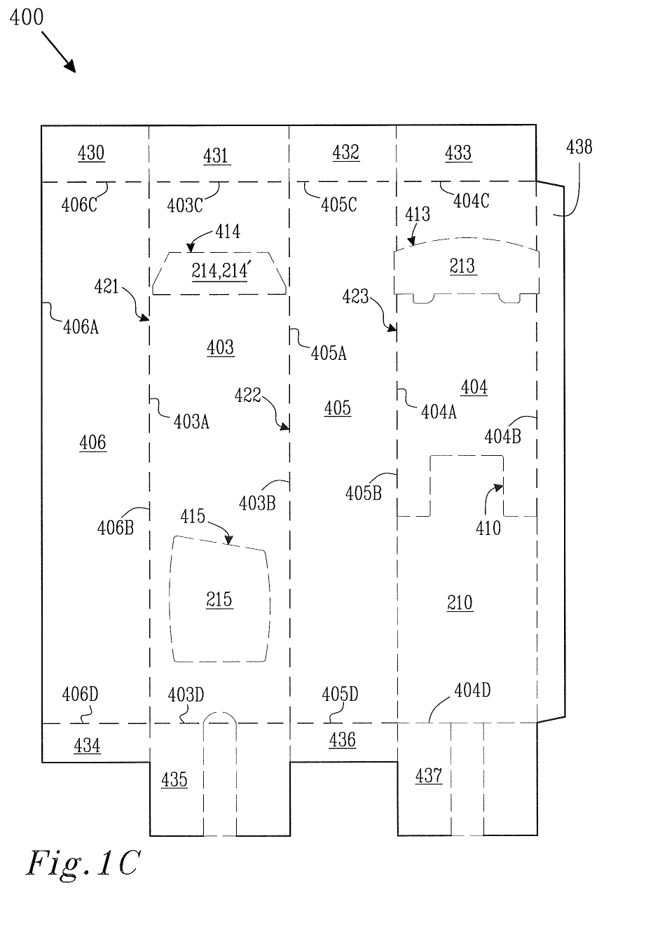

FIGS. 1-5 illustrate embodiments of a container (generally depicted as 200) according to the invention. The container has opposing top 201 and bottom panels 202 separated by a height H, and at least one sidewall 203, 204, 205, 206 extending between said top 201 and bottom panels 202. Accordingly, the container may take a variety of shapes such as triangular prismatic (three sidewalls), cylindrical (one sidewall) or three-dimensional forms with more than three sidewalls (e.g. 4, 5, 6 or more sidewalls).

The following discussion will relate to the cuboid container 200 illustrated in the figures. The illustrated container 200 is cuboid and has four sidewalls 203, 204, 205, 206 consisting of; opposing rectangular front 203 and rear panels 204 separated by a depth D, and first 205 and second 206 opposing rectangular side panels separated by a width W. All panels of the cuboid container 200 illustrated in FIGS. 1-5 are planar and have a rectangular shape. Height H is defined as the shortest distance between top 201 and bottom 202 panels, depth D is defined as the shortest distance between front 203 and rear 204 panels and width W is defined as the shortest distance between side panels 205, 206. Unless otherwise stated, all panels of the container 200 are solid.

The container 200 of the invention may be used to store, transport and display a wide range of products. The products may be loose, individually wrapped or packaged in small numbers. The container may be used for snack products, such as e.g. potato chips, nuts or processed snacks or for confectionery, such as e.g. chocolate or candy bars and packaged candy. The container may also be used for general food products, such as e.g. cooking ingredients or dried food products, or even for personal hygiene products such as e.g. toiletries (e.g. toothpaste, soap bars), sanitary articles (e.g. tampons, sanitary napkins and diapers) or paper tissue products (e.g. facial tissues). Ideally, the products to be stored within the container 200 have a planar form and can be stacked (with their primary face aligned with either the bottom panel 202 or with the front panel 203 of the container 200). The choice of stacking direction of the products relative to the container 200 depends on the weight of the products and the height of the stack.

Typically, the container 200 has a height H of between 10 and 60 cm, a width W of between 3 and 30 cm, and a depth D of between 3 and 20 cm. Suitably, the height H of the container 200 is at least 1.5 times, preferably at least 2 times, more preferably at least 3 times, the width W and/or the depth D of the container 200. A container which has a height H greater than its depth D can be stably arranged on a complementary support system 300 (see below) in stacks of e.g. 2, 3 or 4, which can be easily incorporated into the herring-bone stacking configuration described in the following.

The container 200 of the invention can be made of any material, even combinations of materials, and is suitably rigid. Suitable materials are metals, plastics (e.g. polyethene, polypropylene or polystyrene), cardboard (such as corrugated cardboard) or paper, or mixtures or laminates thereof (e.g. plastic-coated paper or cardboard). The preferred material is cardboard, such as corrugated cardboard. If made of cardboard or paper, the container 200 can be disassembled when empty, flattened out and transported back to the supplier in the flattened state, thus saving energy and space. If made out of plastic, the container 200 may be reusable.

The container 200 comprises a dispensing opening 210 located in a portion of a sidewall 203, 204, 205, 206 in the region adjacent to said bottom panel 202. As shown in FIGS. 1-5, the dispensing opening 210 is located in a portion of the front panel 203 in the region adjacent to said bottom panel 202. The dispensing opening 210 extends through the front panel 203 of the container 200 and allows the consumer to see a product, and remove it from the container 200. In that the dispensing opening 210 is located in the region “adjacent to” the bottom panel 202, there is no container wall in the front panel 203 between the dispensing opening 210 and the bottom panel 202. In other words, the dispensing opening 210 extends along at least a portion of, and preferably the entire, edge defined by the front panel 203 and the bottom panel 202 of the container 200. The dispensing opening 210 can be adapted to allow one full product to be shown.

The dimensions and form of the dispensing opening 210 depend primarily upon the dimensions of the products to be dispensed from the container 200. However, the dispensing opening 210 comprises only a portion of the front panel 203 of the container (i.e. not the entire front panel 203), and, in particular, has a height H1 in the sidewall (front panel 203 in FIGS. 1-5) which is less than the height H of the container 200. The dispensing opening 210 suitably has an extension H1 in the height H direction which is less than 50%, preferably less than 30%, more preferably less than 20% of the total height H of the container 200. A dispensing opening 210 which extends too far in the height H direction (i.e. which takes up too much of the front panel 203) risks that products will fall out, which is particularly relevant considering the steep angles at which the containers 200 of the invention are typically displayed. Furthermore, the fact that the front panel 203 does not entirely comprise dispensing opening 210 means that two or more containers 200 may be stacked upon each other when the dispensing opening 210 is open.

The dispensing opening 210 may have a width which is at least 70%, preferably at least 80%, more preferably at least 90%, of the width W of the container 200. Most preferably, the dispensing opening has a width which is equal to the width W of the container 200, i.e. it extends to at least a portion of each edge defined between the front panel 203 and each side panel 205, 206. The dispensing opening 210 preferably has an axis of symmetry in the plane of the front panel 203 which coincides with the axis of symmetry of the front panel 203 itself. The dispensing opening 210 may have a form which complements the form or design of the products to be dispensed from the container, e.g. the dispensing opening shown in FIGS. 1-5 has a form which allows a logo, typeface or design on a product to be visible, and possibly even enhanced.

In case consumers change their minds about a purchase once a product has been taken from the container 200, it is useful if they are able to replace the product in the container 200. In the present invention, products can be replaced through the dispensing opening 210. In this case, the dispensing opening 210 should have suitable dimensions to allow products to be replaced in the container 200.

The dispensing opening 210 may be located solely in the front panel 203 of the container. Optionally, the dispensing opening 210 also extends into a portion of said bottom panel 202. This arrangement simplifies removal of the products from the container 200, as the user can pull products towards the front panel 203 of the container with their fingers. When the dispensing opening 210 extends into the bottom panel 202, it should not extend completely to both edges defined between the bottom panel 202 and each of the side panels 205, 206, so that products cannot simply fall out of the container 200. As such, the dispensing opening 210 may comprise a channel extending across the bottom panel 202 in the depth direction D, as shown in FIGS. 1-5. The dispensing opening 210 may even extend further a short way (e.g. less than 3 cm or less than 2 cm) from the bottom panel 202 into the rear panel 204, to simplify dispensing. This allows easy access to the last few products in a container, especially when coupled with the support system described below. Alternatively, the dispensing opening 210 may comprise a notch in the bottom panel 202 located at the edge formed by the front 203 and bottom 202 panels. In both cases, the dispensing opening 210 may have a width in the bottom panel 202 which is at least wide enough for insertion of a user's finger, e.g. at least 1 cm, preferably at least 2 cm, more preferably at least 3 cm.

The dispensing opening 210 may be present in the container 200 as manufactured; i.e. a blank used to construct the container 200 incorporates a portion in which material is absent, thus forming the dispensing opening 210. Alternatively, the dispensing opening 210 may be covered by a dispensing cover 216 when the container is manufactured and used for storage (i.e. in the first configuration A); which dispensing cover 216 is removed when the container 200 is used for display and dispensing of products (in the second configuration B). For example, the dispensing cover 216 may be a portion of the front panel 203 of the container 200 which is defined by perforations or lines of weakness, which allows said dispensing cover 216 to be removed. In this case, the dispensing cover 216 comprises the same material as the container 200. Alternatively, the dispensing cover 216 may comprise a different material to that of the container 200, e.g. a plastic film, paper sheet or metal foil, and be secured to the container 200 by any means known in the art (e.g. adhesive or ultrasonic welding). An advantage of using a plastic film is that such films are usually transparent, allowing the contents of the container to be readily seen. If a dispensing cover 216 is used, it is advantageous that a portion of the circumference thereof is not bonded to the container 200, so as to facilitate its removal. For example, a portion of the circumference of the dispensing cover 216 may extend beyond the edges of the dispensing opening 210 to form a removal tab which is not secured to the container 200. Alternatively, a portion of the circumference of the dispensing cover 216 may incorporate one or more through-holes into the container 200, allowing a finger to be inserted to easily remove the dispensing cover 216. A dispensing cover 216, if present, may be completely detached from the container 200 when the container 200 is to be used for display and dispensing of products. Alternatively, it may remain attached to the container 200, and become part of the display features of the container 200. The dispensing cover 216 is designed to be removed from the container quickly and easily, by holding the container 200 in one hand and pulling the dispensing cover 216 with the other hand.

In order to permit the container 200 to be attached to a support system 300 or an identical container 200, the container 200 comprises at least one protrusion 214. The at least one protrusion 214 is suitable for selective releasable cooperation with either a container support system 300 or an identical container 200. The same protrusions 214 may be designed for cooperation with a container support system 300 and an identical container 200. Alternatively, certain protrusions 214 of the container 200 may be suitable for releasable cooperation with a container support system 300, while others may be suitable for cooperation with an identical container 200. The protrusions 214 are integrally formed with at least one of said top panel 201, bottom panel 202 or at least one sidewall 203, 204, 205, 206. The protrusions 214 can be deployed so as to extend from at least one sidewall 203, 204, 205, 206 of the container 200, in a direction opposite to said dispensing opening 210. In other words, the protrusions 214 extend from the opposite side of the container 200 from that in which the dispensing opening 210 is located.

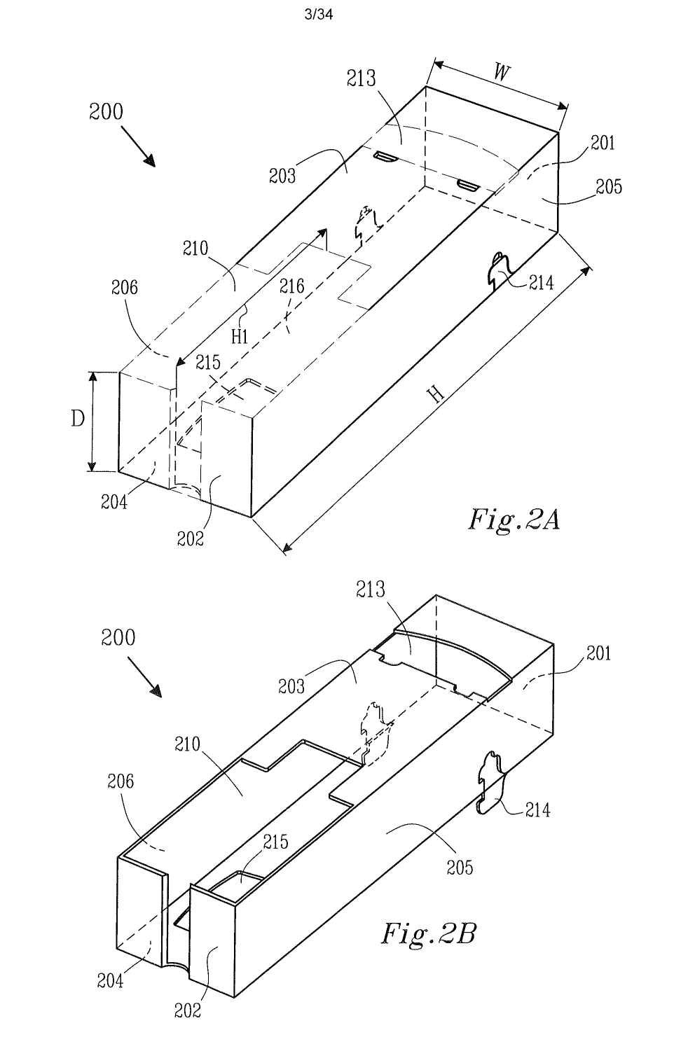

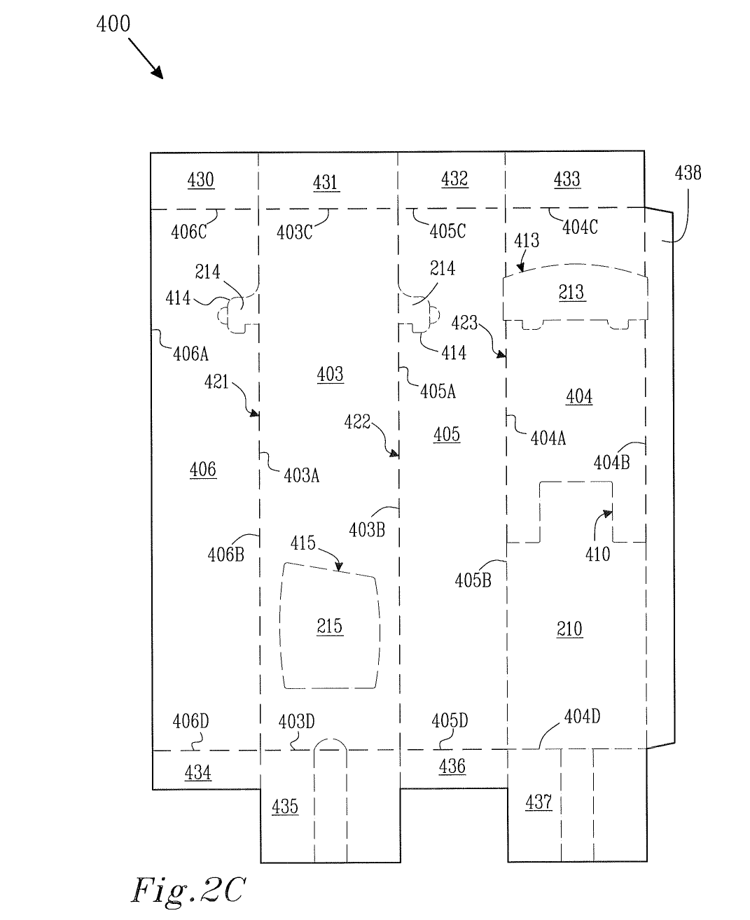

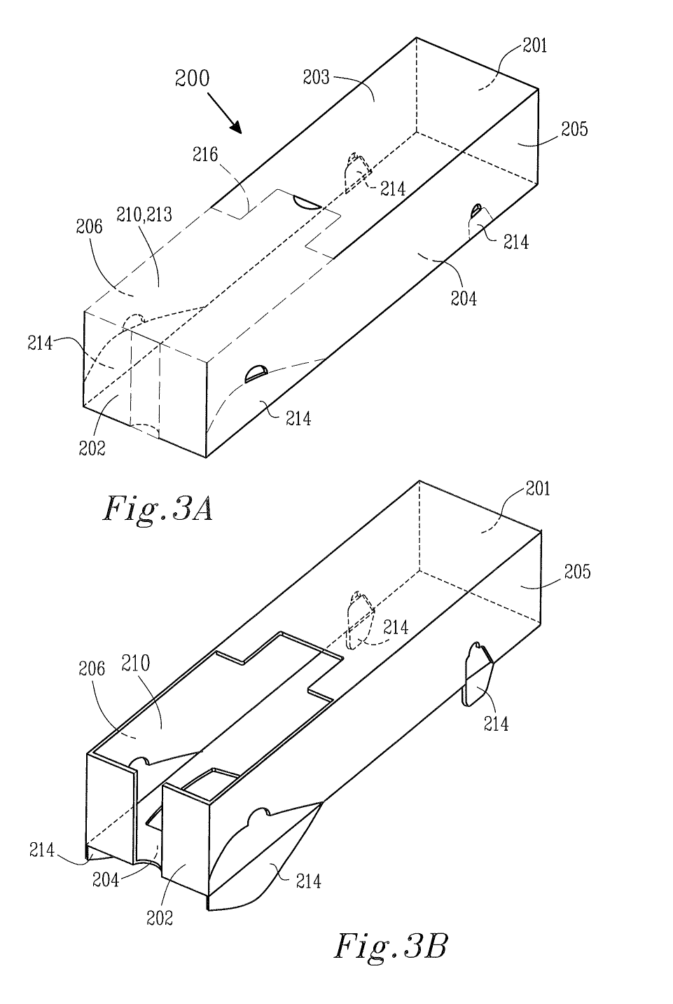

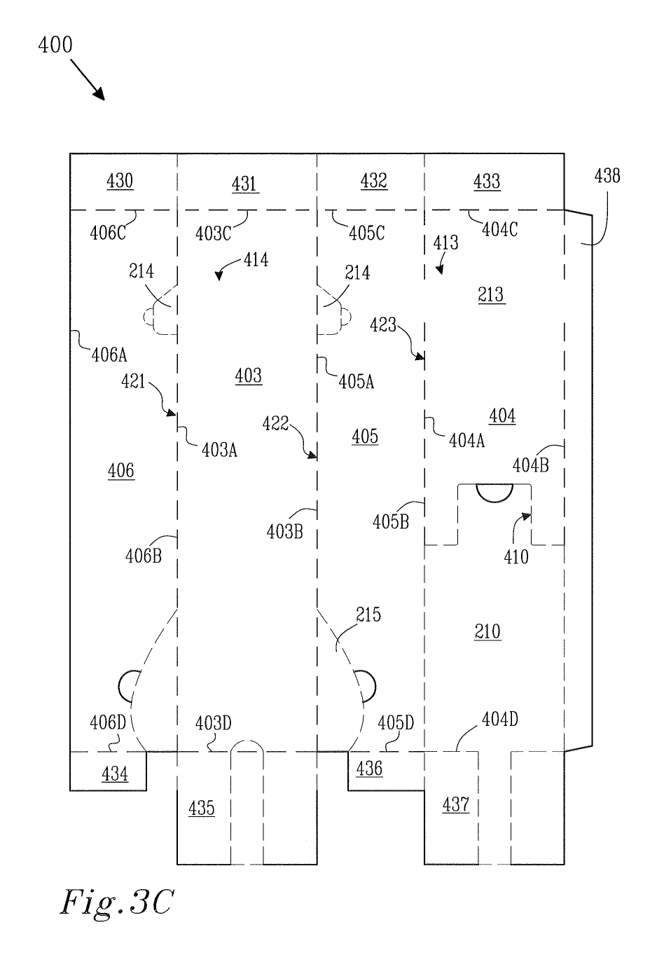

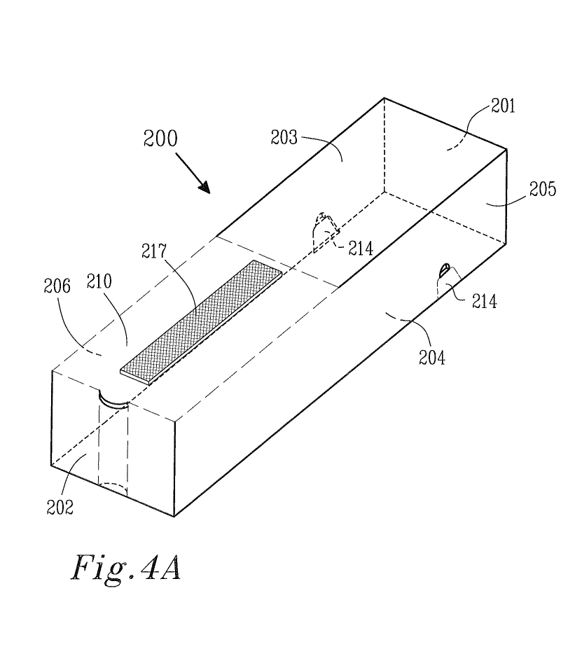

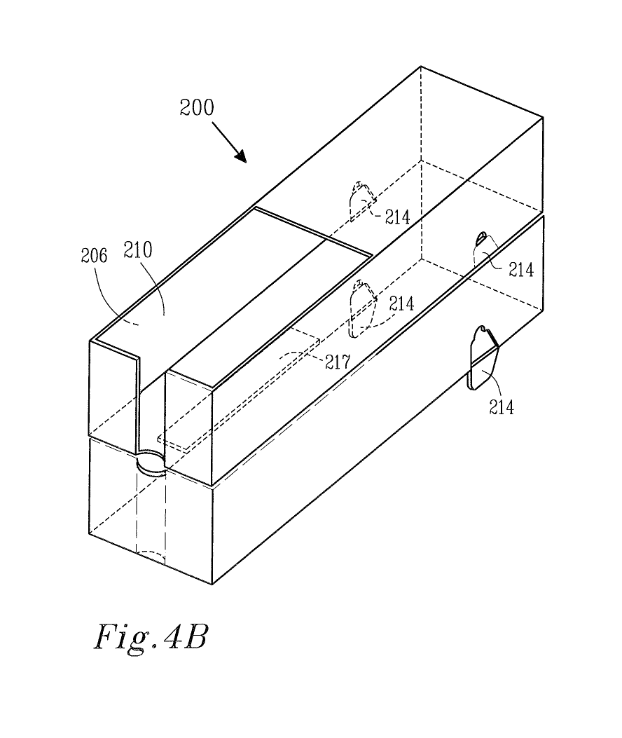

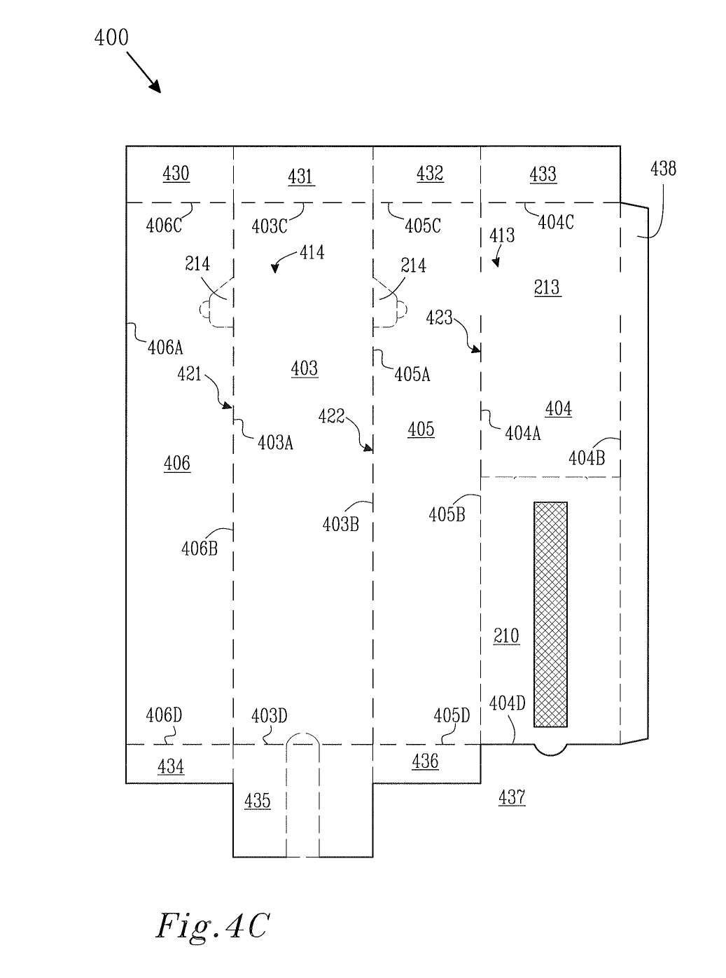

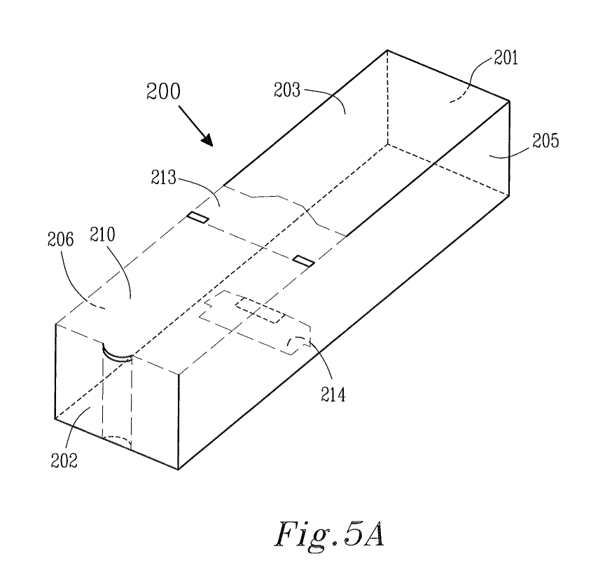

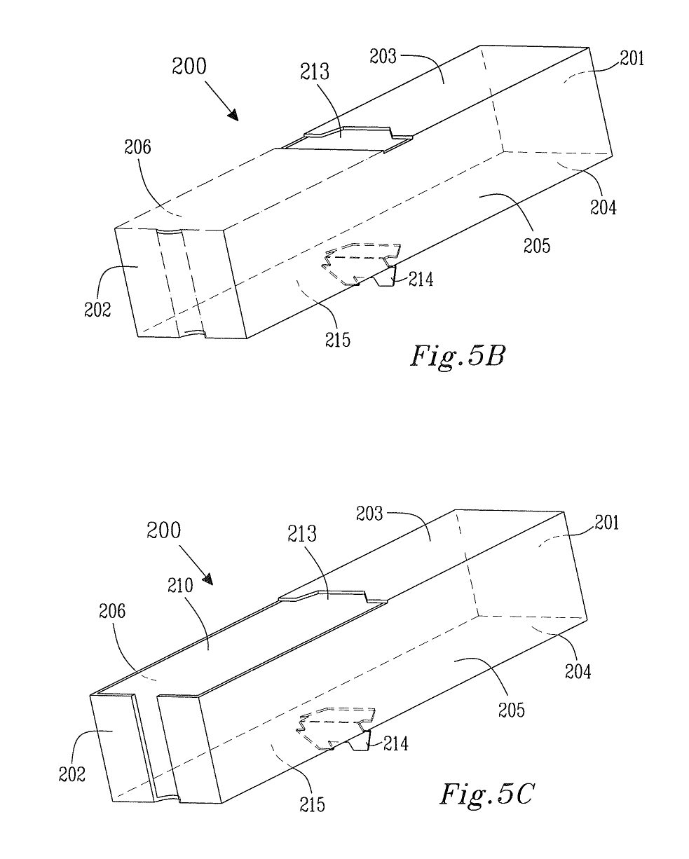

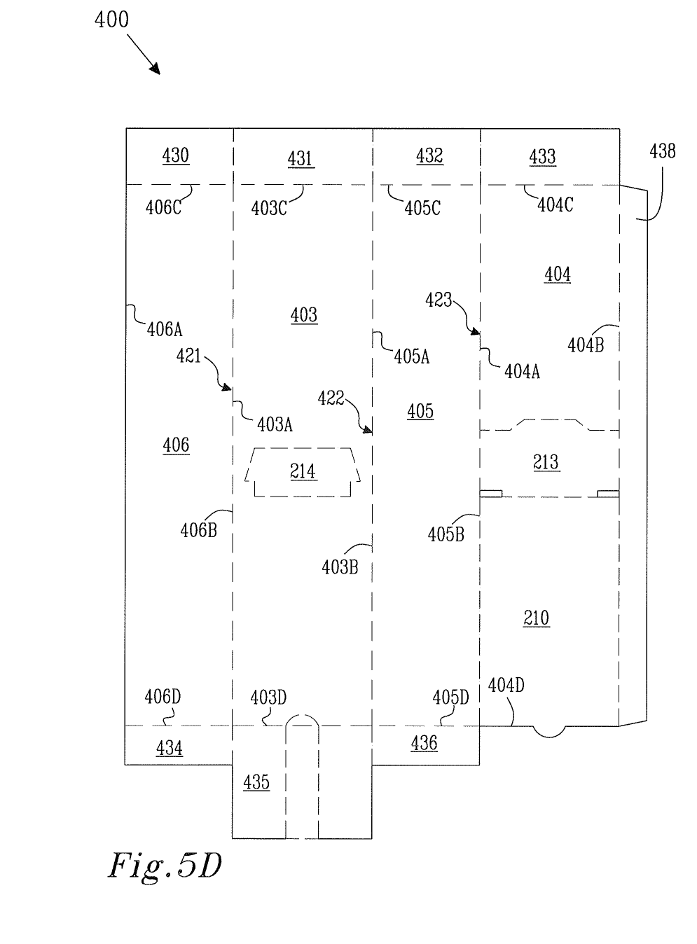

A “protrusion” is defined as a portion of the container 200 which extends from the container, and breaks the otherwise continuous smooth lines of the walls of the container 200. Protrusions 214 may take a number of forms, e.g. flap-shaped (see FIG. 1), hook-shaped, as shown in FIG. 2, rounded (see FIG. 3 or 4), triangular, mushroom-shaped, rod-shaped, rectangular or other forms which will allow the container 200 to be supported on the support system 300. Support may be achieved by the protrusions 214 locking in some way to the support system 300 (e.g. a hook or a mushroom-shaped protrusion 214, in combination with e.g. a wire or keyhole-shaped opening in the support system 300). For example, the protrusion 214 shown in FIG. 5 is similar to the flap 214′ of FIG. 1, except that the edges of the flap 214′ are formed so that they can be locked into an identical container 200 or a support system 300.

The protrusions 214 may simply rely on frictional forces with the support system 300 to keep the container 200 in place while on display (e.g. a ledge or rod-shaped protrusion 214 in combination with a corresponding ledge or opening in the support system 300). The protrusion 214 may comprise a flap in the rear panel 204 which opens towards the top panel 201, and is folded downwards, as shown in FIG. 1 (and FIG. 5). This embodiment provides strength and simplicity. Alternatively, the protrusion 214 comprises a flap in the rear panel 204 which opens towards the bottom panel 202. A further alternative is that the protrusions 214 may be hook-shaped, as shown in FIG. 2.

The container 200 of the invention may comprise any number of protrusions 214. For ease of manufacturing and use, the container 200 may comprise one protrusion 214. To achieve a compromise between manufacturing economy and stability of the container 200 the container may comprise at least 2, preferably between 2 and 8, more preferably between 2 and 4, such as 2, 3, or 4 protrusions. To obtain a stable container, two protrusions 214 may be present, each of which is located the same distance from the top panel 201 of the container 200. As shown in FIGS. 1-5, it is desirable that protrusion(s) 214 are located in a region of the sidewall 203, 204, 205, 206 which lies within 50%, preferably within 40% of the height H of container 200 from the top panel 201 (i.e. the upper region of the container).

The protrusions 214 should be deployable from one sidewall 203, 204, 205, 206 of the container 200 a sufficient distance so that the container 200 cannot easily slip from the support system 300, but not so far that mounting of the container 200 in the support system 300 is made difficult. Suitably, the protrusions extend between 5 mm and 30 mm, preferably between 10 and 25 mm from the sidewall (e.g. rear panel 204) of the container 200 when deployed.

Combinations of protrusions 214 of different forms, sizes and locations can be present on each container 200. Among other things, this allows the manufacturer to tailor the display, in that certain containers 200 only fit at certain locations on the support system 300. In particular, certain protrusions 214 of the container 200 may be suitable for releasable cooperation with a container support system 300, while others may be suitable for cooperation with an identical container 200.

In that the protrusions are to be deployed from the container 200, the container 200 is convertible between a first configuration A in which the protrusions 214 lie in the plane of the top panel 201, bottom panel 202 or sidewall 203, 204, 205, 206 and a second configuration B, in which said at least one protrusion 214 extends from said at least one sidewall 203, 204, 205, 206.

In the first configuration A, the protrusions 214 lie in the plane of the top panel 201, bottom panel 202 or sidewall 203, 204, 205, 206 of the container 200. That is, in the first configuration A, the protrusions 214 form part of, or lie within a recess in, the top panel 201, the bottom panel 202 or the sidewalls 203, 204, 205, 206 of the container 200. The protrusions 214 may constitute a portion of one panel of the container 200, the boundaries of which are perforated or weakened so that the protrusions 214 can be pushed out of the container panel. It is particularly of interest that the protrusions 214 form part of the rear panel 204 of the container 200 in the first configuration A (see FIGS. 1A and 5A). Alternatively, the protrusions 214 can form part of the first or second side panels 205, 206 in the first configuration A, as shown in FIGS. 2A, 3A and 4A. In that the protrusions 214 lie in the plane of the panels of the container 200 in this first configuration A, the container 200 therefore has top 201, bottom, 202, front 203, rear 204 and side 205, 206 panels which are substantially planar. In this way, containers 200 can be stacked upon one another for storage and transport in a stable, closely-packed form.

In the second configuration B, said at least one protrusion 214 extends from said at least one sidewall 203, 204, 205, 206, in a direction opposite to said dispensing opening 210. FIGS. 1B-5B illustrate protrusions extending from the rear panel 204 of the container.

The simplest way to obtain the second configuration B is that the protrusions 214 can be folded out of their positions in the first configuration A. Folding can take place in any direction. The protrusions 214 can lie in the plane of any panel in the first configuration A, but should—when deployed—extend from at least one sidewall 203, 204, 205, 206 of the container. For example, the protrusions 214 can lie in the plane of the top panel 201, but be deployed so as to protrude from the rear panel 204.

Upon receiving the container 200 in the retail outlet, an employee can readily deploy the protrusions 214 and remove any dispensing cover 216 which might be present on the dispensing opening 210. The container 200 is thereby converted to its second configuration B, ready for mounting on a support system 300.

FIG. 1A shows protrusions 214 defined by perforated regions in the form of a flap 214′ in the rear panel 204 of the container 200. The flap is folded out from the rear panel 204 so as to extend from the rear panel 204 in the second configuration B, FIG. 1B. The flap is shown as opening in the direction of the top panel 201 of the container, which is preferred, as a certain resilience is retained, which pushes the flap 214′ away from the container 200 so that it engages securely with the support system 300. The flap 214′ may also open in the direction of the bottom panel 202 of the container.

FIG. 2A shows protrusions 214 defined by perforated regions in the form of hooks in each opposing side panel 205, 206 of the container 200. The hooks are folded out from the side panels 205, 206 so as to protrude from the rear panel 204 (in the second configuration B; see FIG. 2B). The opening in the hook is directed towards the bottom panel 202 of the container, allowing the container 200 to be mounted on the support system 300.

FIG. 3A shows two sets of protrusions 214, defined by perforated regions in each opposing side panel 205, 206 of the container 200. The protrusions 214 located nearest the top panel 201 are folded out in the second configuration B so as to protrude from the rear panel 204, and can engage in a support system 300 of the invention (FIG. 3B). The protrusions 214 located nearest the bottom panel 202 are folded out in the second configuration B so as to protrude from the rear panel 204, and can engage in the dispensing opening 210 of another container 200.

The embodiment of FIG. 4A is similar to that of FIG. 3A, except that the protrusions 214 located nearest the bottom panel 202 are not present. Instead, the front panel 203 of the container 200 of FIG. 4A comprises adhesive tape 217, which is arranged so as to stick the front panel 203 of one container 200 to the rear panel 204 of a second container (see FIG. 4B). The container 200 of FIG. 4A comprises protrusions 214 which can be deployed so as to extend from the rear panel 204 (also shown in FIG. 4B).

The embodiment of FIG. 5A is similar to that of FIG. 1A, except that the protrusion 214 in the form of a flap 214′ has a form which can lock into a support opening 213 of an identical container 200, or into a support means 300. By “lock” is meant that the protrusion 214 can readily be inserted into the support opening 213 or support means 300, but cannot be so easily removed, and is held tightly in place. The container 200 illustrated in FIGS. 5A and 5B comprise protrusions 214 which extend from the rear panel 204.

The front panel 203 of the container is that panel which is presented to the consumer. As such, it may comprise a logo, text, pattern or other design which may be indicative of the nature or origin of the product within said container 200. The design may continue across one or more other panels of the container 200. In addition, portions of a single design may extend over a plurality of containers 200, when arranged in the support system 300, so that a larger design is created.

The container 200 may additionally comprise at least one support opening 213, located in the panel opposite that from which the protrusions 214 extend. The support opening 213 may be separate from the dispensing opening 210; however, the support opening 213 and the dispensing opening 210 may in fact be contiguous, as shown in FIG. 5. FIG. 5 shows that the support 213 and dispensing openings 210 border each other. To form the support opening 213, only that portion of the front panel 203 which covers the support opening 213 is removed. To form the dispensing opening 210, the entire dispensing cover 216 is removed.

If, as in the preferred embodiment, protrusions 214 extend from the rear panel 204 in the second configuration B, the at least one support opening 213 may be located in the front panel 203. If protrusions 214 extend from the front panel 203 in the second configuration B, the at least one support opening 213 may be located in the rear panel 204. The support opening 213 has dimensions and is located such that—when two containers 200 are stacked upon each other—the at least one protrusion 214 on the front/rear panel 203, 204 of one container 200 engages with the support opening 213 on the rear/front panel 204, 203 of the other container 200.

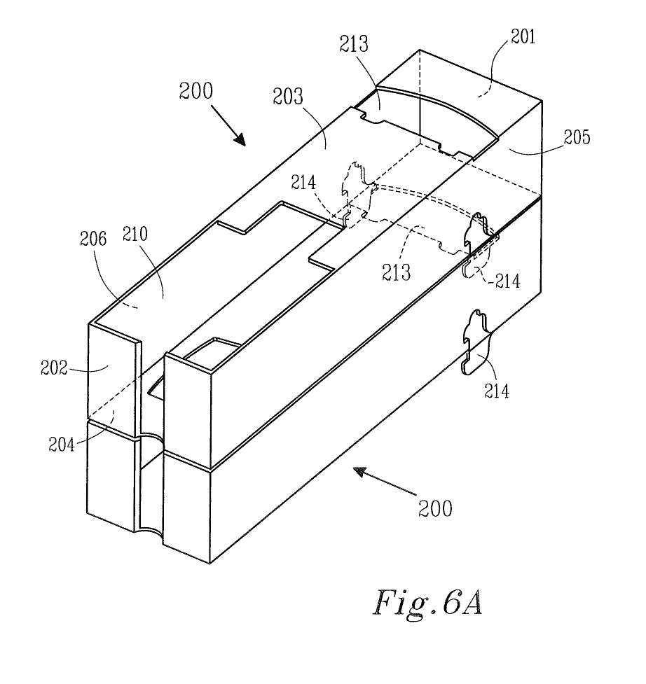

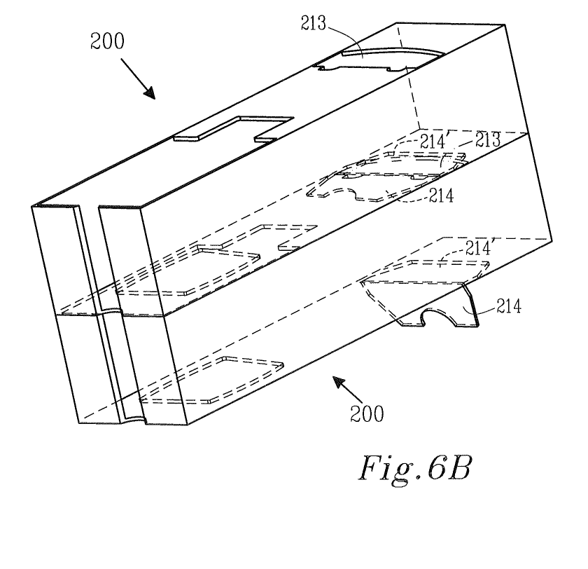

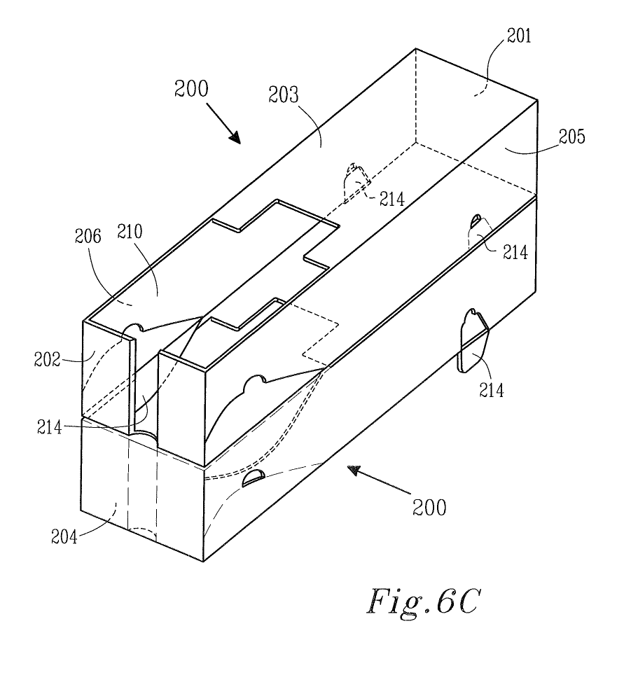

Suitably, the projections 214 on the front or rear panel 203, 204 of the container 200, and the support opening 213 on the front 203 or rear panel 204 of the container 200 are located at a similar distance from the top 201 or bottom 202 panel, so that, when a protrusion 214 on one container 200 engages with the support opening 213 of the other container 200, the top 201 and bottom 202 panels of both containers are aligned flush. This is illustrated in FIGS. 6A, 6B and 6C. FIG. 6A also illustrates that the support opening 213 is formed so as to be able to receive protrusions 214 (in this case, hooks), and hold them fast, thus locking two containers together, as the resilience of the material of the protrusions 214 pushes them outwards towards the side panels 205, 206. FIG. 6B shows how the two containers according to FIG. 1 are locked together—the flap 214′ of the upper container slides into the gap between the products and the top panel of the lower container, and is held in place there. FIG. 6C illustrates how the two pairs of protrusions of the container 200 of FIG. 3 are employed—one pair is designed to reversibly engage with the support means 300, while the other pair is designed to reversibly engage with an identical container 200 by means of the dispensing opening 210.

The support opening 213 may also be covered when the container 200 is used for storage and transport (i.e. in the first configuration A), in the same way as the dispensing opening 210, so that it may be uncovered (in the second configuration B) for display and dispensing. For example, when two containers 200 are stacked above one another, the support opening 213 in the lower container 200 should be open to receive the projections 214 of the upper container, but the support opening 213 in the upper container need not be opened. Furthermore, the dispensing cover 216 used to cover the dispensing opening 210 may be partly removed to form a support opening 213, and removal of the entire dispensing cover 216 forms the dispensing opening 210. This is shown in FIGS. 5B and 5C: part of the dispensing cover 216 is removed in FIG. 5B to form the support opening 213. This arrangement is suitable when stacking two identical containers 200 of FIG. 5 on top of one another. When a container 200 is to be used for dispensing, the entire dispensing cover 216 is removed, as shown in FIG. 5C.

In that two containers 200 can lock together, they can be mounted on the support system 300 in pairs (one above the other), which is desirable for the retailer as the upper container can be used for dispensing products, while the lower container acts as a reserve for use when the upper container is empty. This is illustrated in FIGS. 6A-6C. However, containers 200 may also be mounted on the support system 300 in one layer.

Desirably, the same projections 214 are used for cooperation with an identical container 200 (i.e. engaging with the support opening 213) as for engaging with the support system 300. However, as mentioned above and illustrated in FIG. 3A-3C, certain projections 214 may be suitable for releasable cooperation with a container support system 300, while others may be suitable for cooperation with an identical container 200.

As an alternative to the support opening 213, two or more containers 200 may be supported on one another by means of adhesive tape 217, as shown in the embodiment of FIG. 4A-4B. In this case, a strip of adhesive tape 217 is located on the front panel 203 of a container 200, with the adhesive facing outwards. Should a retailer wish to stack two containers 200 above one another on a single support system 300, the adhesive tape 217 is uncovered (e.g. by removing a protective strip) and a second container 200 can be adhered to the first container 200 via the adhesive tape 217. An alternative is that the adhesive tape 217 is located on the rear panel 204 of an upper container 200, and sticks to the front panel 203 of an underlying container 200.

The rear panel 204 of the container 200 may additionally comprise a viewing opening 215 (see FIGS. 1A, 1B and 2A, 2B), located in said bottom panel 202, preferably in the lower region thereof. The dimensions of the viewing opening 215 are suitably smaller than those of the dispensing opening 210, so that products cannot fall out or be removed from the container 200 via the viewing opening 215. The viewing opening 215 may therefore have a width which is between 30% and 80%, preferably between 40% and 70%, more preferably between 50% and 60%, of the width W of the container 200. When two or more containers 200 are stacked upon one another, and the upper container becomes empty, the viewing opening 215 allows a consumer to see that underlying container contains the desired product, prompting them to remove the upper container and to obtain products from the underlying container. The viewing opening 215 may also be covered in the first configuration A, so as to protect the contents of the container 200, but uncovered in the second configuration B.

The present invention also relates to a blank 400 suitable for forming the container 200 of the invention. FIGS. 1C, 2C, 3C, 4C and 5D show blanks 400 suitable for forming the containers 200 illustrated in FIGS. 1A, 2A, 3A, 4A, and 5A, respectively. In FIGS. 1C, 2C, 3C, 4C and 5D, score (i.e. fold) lines are indicated by dashed lines, while perforations are indicated by alternating dash-dot lines.

The blanks 400 illustrated in FIGS. 1C, 2C, 3C, 4C and 5D comprise:
a first rectangular panel 403 having opposing side edges 403A, 403B and opposing end edges 403C, 403D, wherein each of said opposing side edges 403A, 403B has a length H corresponding to the height H of the container 200 and each of said opposing end edges 403C, 403D has a length W corresponding to the width W of the container 200;
second 405 and third 406 rectangular panels, each having opposing side edges 405A, 405B, 406A, 406B and opposing end edges 405C, 405D, 406C, 406D, wherein each of said opposing side edges 405A, 405B, 406A, 406B has a length H corresponding to the height H of the container 200 and each of said opposing end edges has a length D corresponding to the depth D of the container 200;
a fourth rectangular panel 404 having opposing side edges 404A, 404B and opposing end edges 404C, 404D, wherein each of said opposing side edges 404A, 404B has a length H corresponding to the height H of the container 200 and each of said opposing end edges 404C, 404D has a length W corresponding to the width W of the container 200; and
flaps 430, 431, 432, 433, 434, 435, 436, 437 extending from the opposing end edges 403C, 403D, 405C, 405D, 406C, 406D, 404C, 404D of at least three of said rectangular panels 403, 404, 405, 406, said flaps 430, 431, 432, 433, 434, 435, 436, 437 being adapted to constitute top 201 and bottom 202 panels of said container 200. In that the flaps 430, 431, 432, 433, 434, 435, 436, 437 are adapted to constitute top 201 and bottom 202 panels of the container 200, it means that, when they are overlapped during assembly of the container, the dimensions of the flaps 430, 431, 432, 433, 434, 435, 436, 437 are sufficient to cover the area defined by the top 201 and bottom 202 panels of the container 200. For example, flaps 430, 432, 434, 436 located on the second 405 and third 406 rectangular panels may all be the same size and extend from the blank 400 a distance corresponding to half the width W of the container 200, so that when the container 200 is assembled, flaps 430, 432, 434, 436 form the top 201 and bottom 202 panels of the container 200.

The second and third rectangular panels 405, 406 are located on either side of the first rectangular panel 403 such that each of said opposing side edges 403A, 403B of the first rectangular panel 403 is joined to one opposing side edge 405A, 406B of the second and third rectangular panels 405, 406 and separated therefrom by score lines 421, 422. The fourth rectangular panel 404 is located adjacent the second rectangular panel 405, such that the opposing side edge 404A of the fourth rectangular panel 404 is joined to the other opposing side edge 405B of the second rectangular panel 405 and separated therefrom by score line 422. A flap 438 is located on the opposing side edge 404B of the fourth rectangular panel 404 which is not joined to the second rectangular panel 405; or the opposing side edge 406A of the third rectangular panel 406, for connecting the opposing side edge 406A of the third rectangular panel 406 to the opposing side edge 404B of the fourth rectangular panel 404.

The fourth rectangular panel 404 comprises means 410 for forming a dispensing opening 210, adjacent to one end edge 404C thereof. This means 410 for forming a dispensing opening 210 may comprise perforation lines or weakening or a cut-out corresponding to the shape of the dispensing opening 210. As mentioned above, the dispensing opening 210 may be covered by a dispensing cover 216 which comprises the same material as the container 200 and is defined by perforations or lines of weakness or which comprises a different material to that of the container 200, e.g. a plastic film, paper sheet or metal foil. The means 410 for forming the dispensing opening 210 has an extension H1 in the height H direction which is suitably less than 50%, preferably less than 30% of the total height H of the container 200.

At least one of the first 403, second 405, third 406 or fourth 406 rectangular panels comprises means 414 for forming at least one protrusion 214. FIG. 1C shows that the first rectangular panel 403 comprises a protrusion 214 in the form of a flap 214′ defined by perforated regions. As shown in FIG. 2C, the second 405 and third 406 rectangular panels comprise protrusions 214 in the form of hooks defined by perforated regions. FIG. 3C shows that the second 405 and third 406 rectangular panels comprise two pairs of protrusions 214 defined by perforated regions. FIG. 4C shows the second 405 and third 406 rectangular panels comprising protrusions 214 defined by perforated regions. FIG. 5D shows that the first rectangular panel 403 comprises a protrusion 214 in the form of a locking flap defined by perforated regions.

The fourth panel 404 may additionally comprise means 413 for forming a support opening 213. The first panel 403 may additionally comprise means 415 for forming a viewing opening 215.

Although the blank 400 has been described with reference to the embodied containers 200, the skilled person will be able to design blanks within the scope of the invention which are suitable for forming any defined container 200, in particular, with any desired form of protrusions 214.

The particular arrangement of the features of the container 200 allows the container to be supported on the support system described herein without obstructing the bottom panel 202. This allows ready access to products within the container 200, particularly when the container only contains a few products.

### Support System

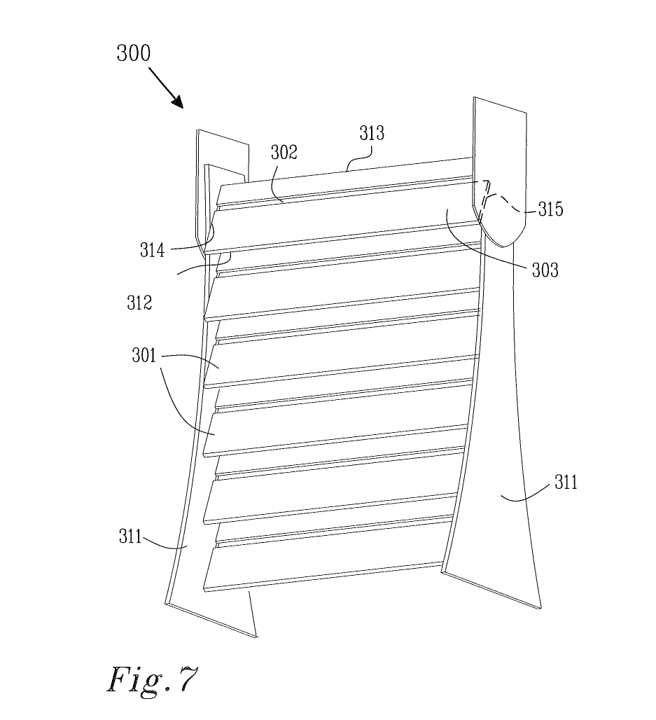

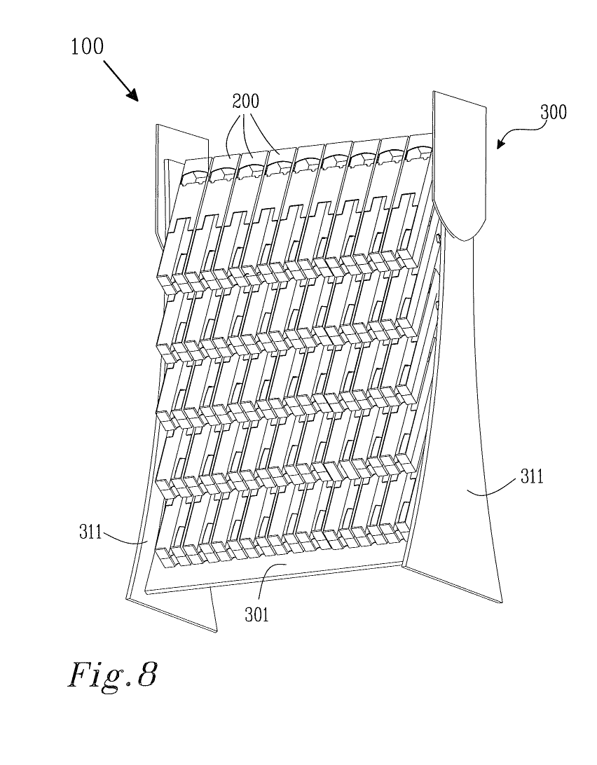

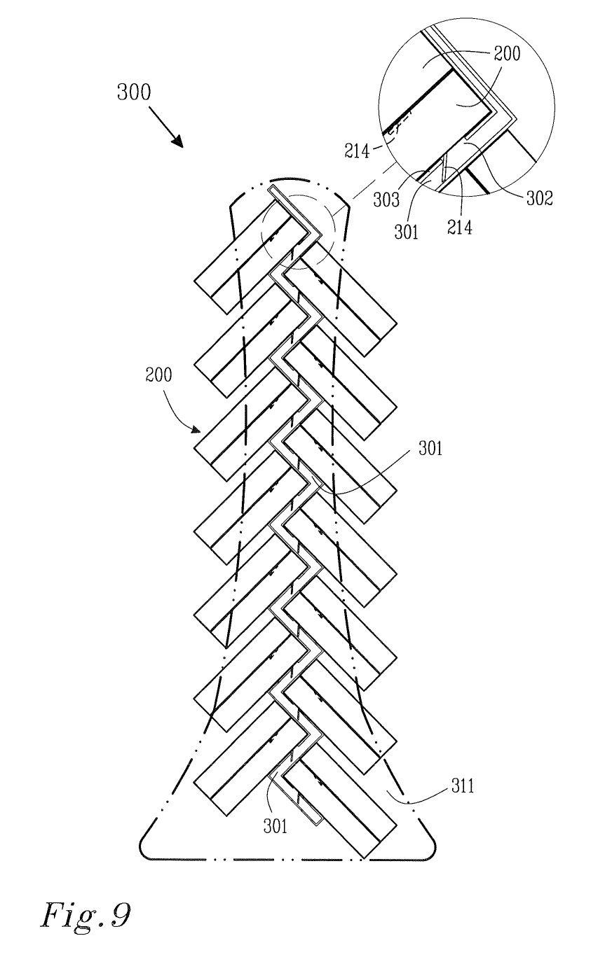

The support system 300 of the invention is exemplified in FIGS. 7-15, and shown in its entirety in FIG. 7. It comprises at least one frame 301. A frame 301 is a structure which extends in at least one horizontal plane, and is adapted to support a row of containers 200 according to the invention. Frames 301 can be connected to each other to build up the support system, or can be connected by additional members (e.g. rods, wires, panels, legs, etc). Typically, the support system comprises at least two frames 301, such as e.g. at least 3, at least 4, at least 5, at least 6 or at least 10 frames 301. The frames 301 are arranged vertically above each other. In this way, at least two rows of containers 200 can be supported on the support system 300. Typically, the frames 301 have a rectangular shape, and may be solid (e.g. shelving, see FIG. 7) or open (e.g. a framework).

The support system 300 may be free-standing or wall-mounted. It may be designed to stand on the floor. If free-standing, the support system 300 typically comprises one or more legs 311 upon which the one or more frames 301 are supported. However, it may be possible for the support system to be floor standing, and not comprise legs 311 (e.g. the frames may be interconnected so as to support each other).

Any design of frame 310 and legs 311 which is known in the art for regular shelves can be used in the support system 300. Typically, as per a standard shelf, frames 301 extend horizontally between two or more legs 311 (see FIG. 7). However, other arrangements of legs 311 and frames 301 may be used; e.g. frames 301 extending horizontally from a single wide leg 311 or circular frames 301 supported on a single leg 311, around which containers 200 can be supported in a “Christmas tree” arrangement or a spiral arrangement. The frames 301 may be permanently joined to the legs 311, or may be detachably joined, so that a retailer can adapt the support system 300 according to their requirements.

If wall-mounted, the support system 300 typically comprises at least one frame 301 upon which the containers 200 are supported, and one or more brackets 312 by means of which the frames 301 are fastened to the wall.

The support system 300 may be made of metal, plastic, wood, cardboard or combinations thereof.

The frames 301 of the support system 300 comprise at least one first support means 302 which is adapted to engage with said at least one protrusion 214 on the container 200, thus preventing the container 200 from sliding down in the direction of the bottom panel 202 of the container 200. The first support means 302 therefore has a form which is suitable for engaging with the protrusions 214 on the container 200, thus keeping the container 200 on the support system 300. The protrusions 214 extending from the container 200 in the second conformation B can fit into place over the first support means 302, and the container 200 is thus prevented from sliding down in the direction of the bottom panel 202.

The first support means 302 comprises a wire, rod, ledge, thread or cut-out extending in the horizontal plane across substantially the entire frame 301. Containers 200 are hung via their projections 214 upon the first support means 302 (see FIG. 10). Such first support means 302 has the advantage that the containers 200 are free to slide horizontally along the frame 301, providing flexibility in the display of the containers 200. A frame 301 may comprise a shelf which has a first support means 302 in the form of a cut-out extending substantially completely across the entire frame 301 in the horizontal plane, into which the projections 214 on the container 200 can be inserted. This is particularly relevant for the containers shown in FIGS. 1 and 5, in which the protrusions 214 in each case are folded down and slotted into a cut-out in the frame (see FIG. 10).

Each frame 301 is typically rectangular, and is aligned at an angle to the horizontal, such that it comprises a lower front edge 312, an upper rear edge 313 and two side edges 314, 315. The frames 301 do not comprise means such as a ledge, protrusion, or lip at the lower front edge 312 thereof, which is adapted to contact the bottom panel 202 of the container. In other words, the only component of the frame 301 which prevents the container 200 from sliding down in the direction of the bottom panel 202 is the first support means 302, and this first support means 302 is not located at the lower front edge 312 of the frame. The support system 300 can therefore take up less space when empty, and the same support system 300 can incorporate containers 200 of different heights H, with their top panels 201 aligned. In particular, the lack of a ledge, protrusion or lip at the lower front edge 312 of the frame 301 means that the last few products in the container 200 are easier to access, in particular given the arrangement of the dispensing opening 210 described above, in which the dispensing opening 210 extends into the bottom panel 202 or even from the bottom panel 202 into the rear panel 204. This can be seen most clearly in FIG. 10. In other words, the support system 300 of the invention is designed so that the bottom panel 202 of the container 200 is not obstructed when supported on said support system 300.

The frames 301 of the support system 300 also comprise at least one second support means 303 which prevents the container 200 from rotating about an axis perpendicular to the two opposing side panels 205, 206.

As per the first support means, 302, the second support means 303 may be a wire, rod or thread extending in the horizontal plane, upon which containers 200 may rest. The second support means 303 suitably extends in the horizontal plane across substantially the entire frame 301. The frame 301 may therefore comprise a pair of parallel wires, rods or threads extending in the horizontal plane. The second support means 303 may also comprise a projection which extends under the rear panel 202 of each container 200, in the direction of the bottom panel 204 thereof. If the frame 301 comprises a shelf in which the first support means 302 has the form of a cut-out extending in the horizontal plane, the lower part of the shelf constitutes the second support means 303. In the embodiments shown in FIGS. 7-10, the second support means 303 is arranged to lie under the rear panel 204 of the container. The second support means 303 may optionally engage with at least one protrusion 214 on the container 200, however, it is preferred that the second support means 303 does not prevent the container 200 from sliding down in the direction of the bottom panel 202, but rather its only function is to prevent the container 200 from rotating about an axis perpendicular to the two opposing side panels 205, 206.

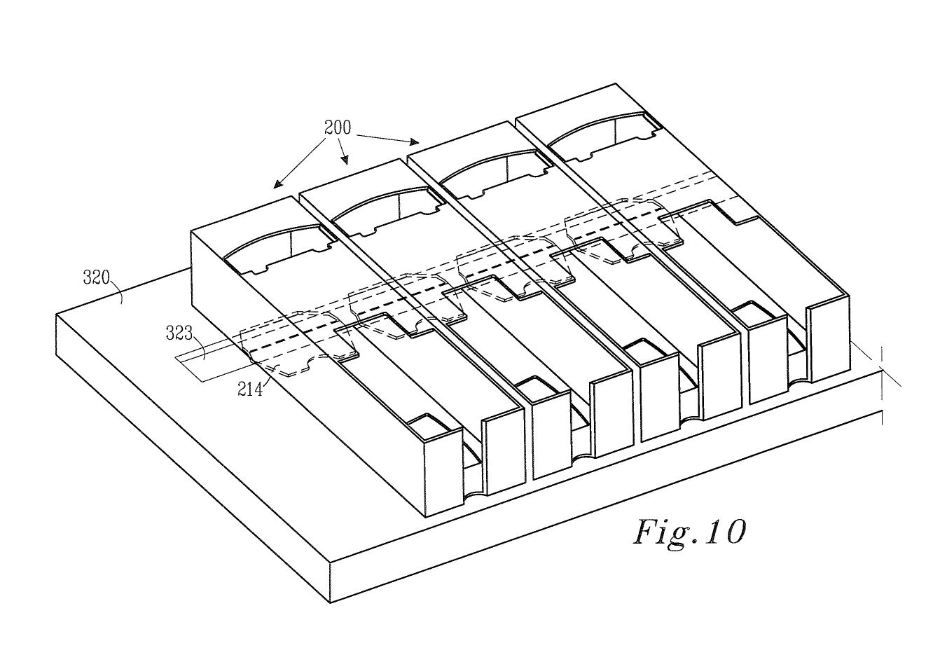

Combinations of first 302 and second 303 support means may be chosen by the skilled person. The combination of the first 302 and the second 303 support means allows the containers 200 to be maintained on the support system 300 such that the panel of the container 200 from which the protrusions 214 extend makes an angle with the horizontal plane of between 10 and 80°, preferably between 20 and 70°, more preferably between 30 and 60°, as shown in FIGS. 8-9. The second 303 support means is thus typically located below and in front of the first support means 302, as seen from the direction of the bottom panel of a container 200. The sloping angle allows good presentation and accessibility of the products in the container 200, while using gravitational force so that products slide towards the dispensing opening 210. The sloping angle can be chosen according to the weight of the product in the container 200 and/or frictional forces between the product and the inside of the container 200. For example, for products which can roll, the angle can be closer to the horizontal. The most preferred angle at which the containers 200 are maintained is 45° to the horizontal, as this allows the frames 301 in the support system 300 to be arranged such that the upper edge of each frame 301 meets the rear face of an overlying frame 301, said frames 301 being aligned at an angle of 90° as seen from one end of the support system 300. A herring-bone pattern of containers 200 is thus achieved, leading to great savings in space. This is illustrated in FIG. 9.

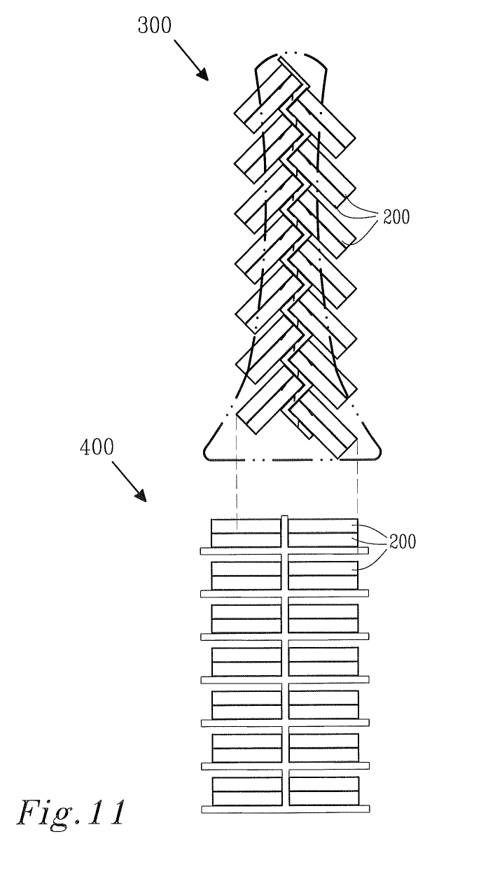

For a given container size, a comparison can be made between the herringbone pattern of FIG. 9 and containers 200 stacked double in height on conventional horizontal shelves 600. For good access to the products and to obtain a reasonable total height—a suggested maximum of seven of the conventional horizontal shelves 600 or the frames 301 of the present invention can be stacked above one another. FIG. 11 shows that—using the herring-bone pattern of containers 200—the same number of containers 200 can be arranged in less floor space than containers 200 arranged on horizontal shelving 600.

A particular support system 300 has been designed for use with a container 200 in which the protrusion 214 comprises a flap 214′ in the rear panel 204 of the container 200, which opens in the direction of the top panel 201 of the container 200. This embodiment of the container 200 is readily manufactured and easy to use, and the flap 214′ exhibits a resilience when deployed in the second configuration B which pushes it away from the rear panel 204, and secures it in the support system 300.

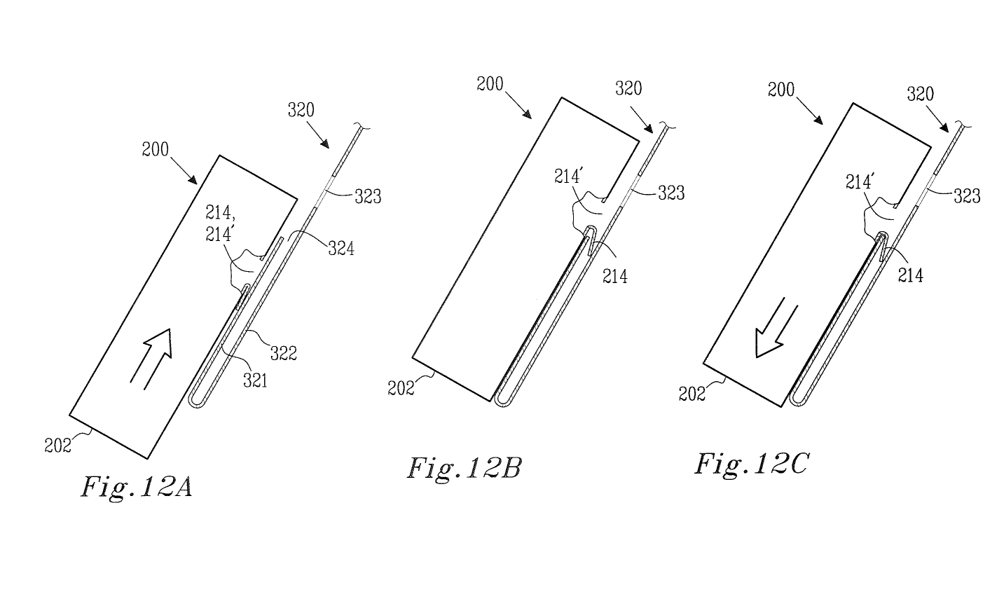

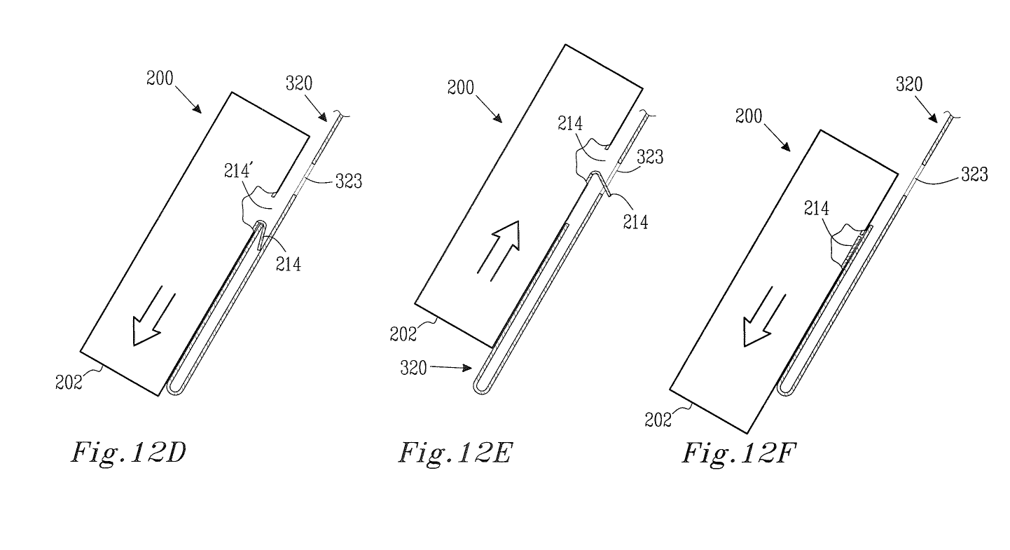

This particular support system 300 is illustrated in FIGS. 12A-12F, in cross-sectional view. FIGS. 12A-C illustrate how a container 200 is mounted on the support system 300, while FIGS. 12D-F illustrate how a container 200 is removed from the support system 300.

The support system 300 comprises at least one shelf 320. The shelf 320 has at least a front member 321 and a rear member 322. The front member 321 is arranged to lie between the rear member 322 and the container 200 in use, and bears the container 200 in use.

Together, the front member 321 and rear member 322 define a space 324 which has a maximum extension in a direction perpendicular to the plane of the shelf 320 which is less than the length of said flap 214′. Once inserted into the space, therefore, the flap 214′ cannot invert, and holds the container 200 on the shelf 320.

The rear member 322 optionally comprises an opening 323 in the rear member 322 for receiving the distal end of the flap 214′. As shown in FIGS. 12A-F, the opening 323 is located higher in the plane of the shelf than the space 324 defined by the front 321 and rear 322 members. In other words, the space 324 and the opening 323 are arranged with respect to each other in the plane of the shelf 320 such that mounting and removal of a container can be carried out as described in the following.

The sequence in FIGS. 12A-C illustrate how a container 200 is mounted on the support system 300. Firstly, the protrusion 214 in the form of the flap 214′ is deployed from the rear panel 204 of the container 200, and folded back towards the bottom panel 202 so as to lie against the rear panel 204 of the container 200. The container 200 is placed on the shelf 320, on its rear panel 204. The user then slides the container 200 up the shelf (as indicated in FIG. 12A) until the distal end of the flap 214′ passes the front member 321. At this point, the flap 214′ is free to move away from the rear panel 204, as illustrated by the arrow in FIG. 12B. Depending on the resilience of the container material, this point on the movement of the container can be indicated by an audible “click”, as the flap 214′ contacts the rear member 322. When the container is moved slightly down towards the bottom panel 202 from this point, flap 214′ engages in the space 324 between the front 321 and rear 322 members (as illustrated in FIG. 12C). The container 200 is thus held securely in place during display and dispensing of products.

To remove a container 200 from the shelf 320, the container 200 may be lifted in a direction substantially perpendicular to the plane of the shelf 320. However, if the rear member 322 comprises an opening 323, the container may simply be displaced further upwards in the plane of the shelf (as illustrated in FIG. 12D), such that the distal end of the flap 214′ enters the opening 323 (as illustrated in FIG. 12E). This point on the movement of the container can also be indicated by an audible “click”, as the flap 214′ contacts the edge of the opening 323. Subsequently pulling the container 200 towards the bottom panel 202 in the plane of the shelf 320 causes the flap 214′ to be inverted in the opening 323, and allows the container 200 to be withdrawn (as illustrated in FIG. 12F).

The support system 300 illustrated in FIGS. 12A-F and 13-15 has the advantage that the displacement of the container 200 is substantially in the plane of the shelf 320. Displacement of the container away from the shelf 320 can be minimised. As well as making the support system 300 easy to use, the absence of any displacement of the container 200 away from the shelf 320 means that shelves 320 can be arranged very close together, maximising the use of space, as the container 200 essentially slides in and out of the shelf 320.

FIGS. 12A-F illustrate a preferred embodiment of the shelf which is made of one single piece of material which is bent to form the front member 321 and the rear member 322, respectively. This has the advantage that there is no hindrance presented when mounting the container 200.

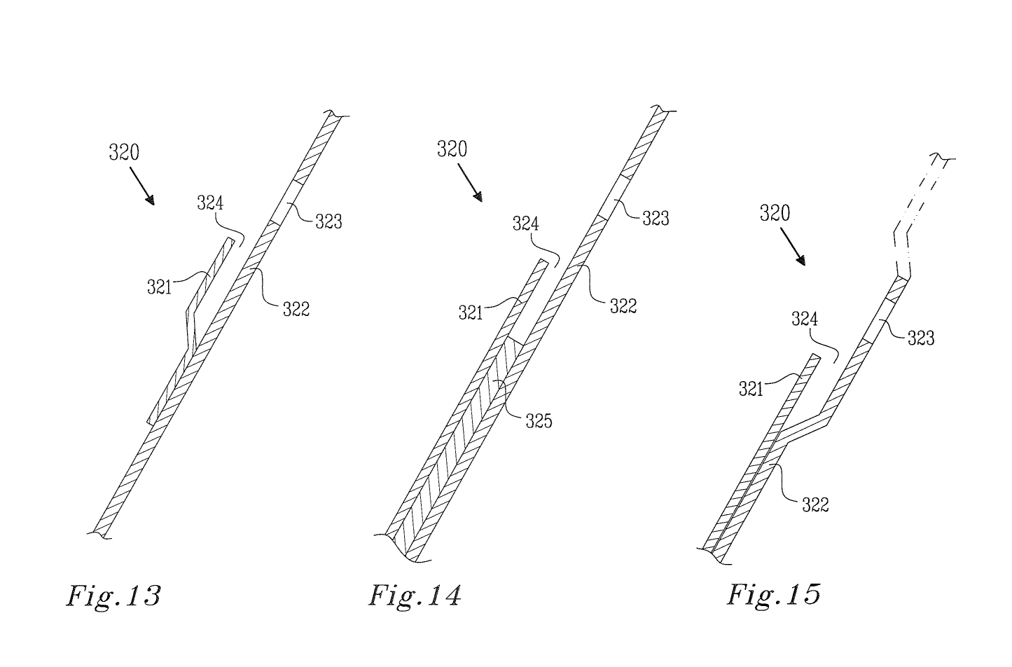

However, the support system 300 may take other forms, as shown in FIGS. 13, 14 and 15. FIG. 13 illustrates a shelf 320 in which the rear member 322 is substantially flat, and comprises an opening 323. The front member 321 is a separate piece which is attached to the rear member 322, so as to define a space 324, as shown. The front member 321 may be substantially flat, and attached to the rear member 322 at an angle; alternatively, it may be bent, as shown in FIG. 13.

FIG. 14 illustrates a shelf 320 in which the rear member 322 is substantially flat, and comprises an opening 323. The front member 321 is a separate piece which is also substantially flat, and which is attached to the rear member 322 via a spacing member 325 so as to lie essentially parallel with the rear member 322, thus defining a space 324.

FIG. 15 shows a shelf 320 in which the front member 321 is substantially flat. The rear member 322 is joined to the front member via an angled region so as to define a space 324. The rear member 322 incorporates the opening 323. The rear member 322 may even be angled in the region above the opening 323, so that the container 200 can also be supported on this portion of the rear member 322.

Other variants of the shelf 320 can be designed by the skilled person, depending on the placement of the container 200 and the location and arrangement of the flap 214′.

### Adaptor

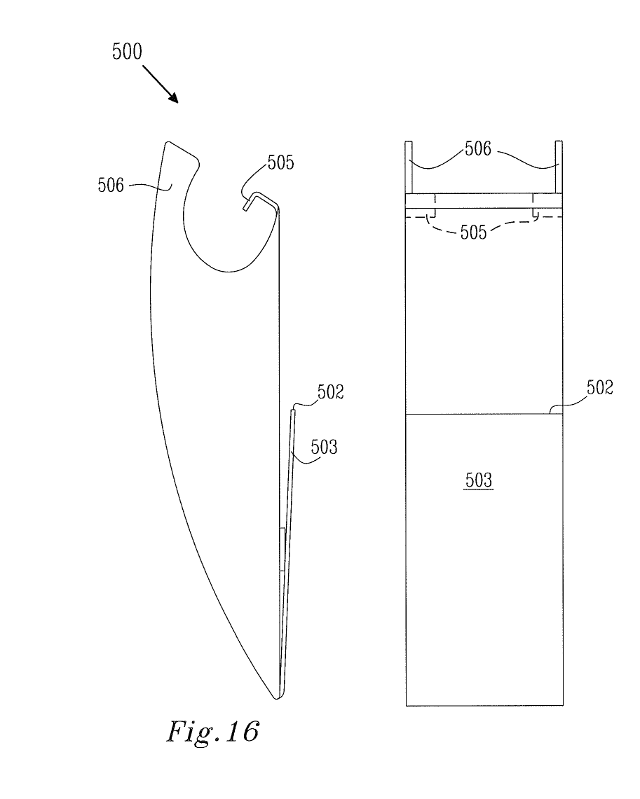

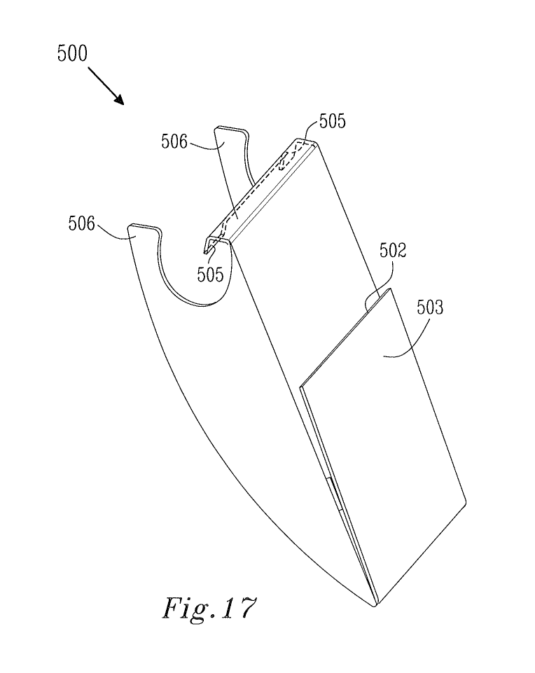

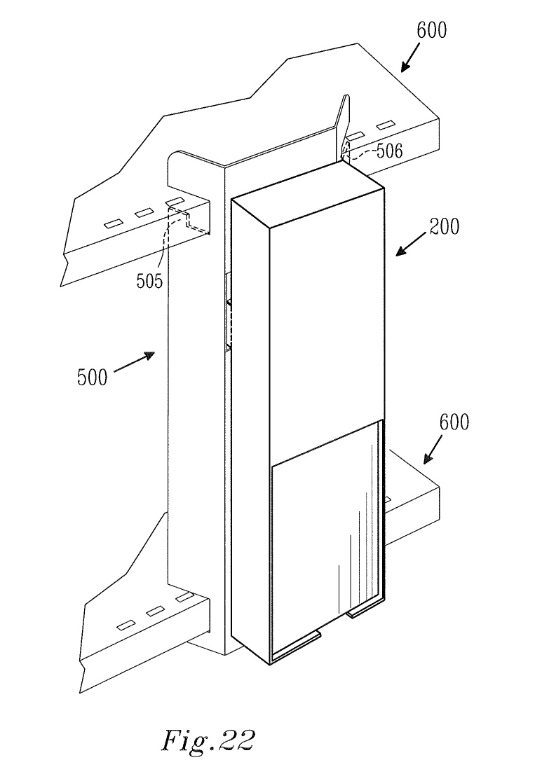

The invention also provides an adaptor 500 which makes it possible to use the container of the invention on traditional horizontal shelves. Examples of various forms which the adaptor 500 may take are illustrated in FIGS. 16-26. Preferably, the adaptor 500 can support one container 200, but—if desired—the adaptor 500 may be designed to support more than one container 200, e.g. 2, 3, 4, 5 or more containers 200, in a side-by-side arrangement. The adaptor 500 may also support more than one container 200, e.g. 2 or 3 containers on top of one another.

The adaptor 500 is used for adapting at least one substantially horizontal shelf 600 so as to be able to support a container 200 according to the invention at an angle to the horizontal shelf 600. The adaptor 500 may be made of metal, plastic, wood, cardboard or combinations thereof.

In a similar way to the support system 300 above, the adaptor 500 of the invention comprises at least one first support means 502 which is adapted to engage with said at least one protrusion 214 on the container 200, thus preventing the container 200 from sliding down in the direction of said bottom panel 202 of said container 200. The first support means 502 therefore has a form which is suitable for engaging with the protrusions 214 on the container 200, thus keeping the container 200 on the adaptor 500. The protrusions 214 extending from the container 200 in the second conformation B can fit into place over the first support means 502, and the container 200 is thus prevented from sliding down in the direction of the bottom panel 202 thereof.

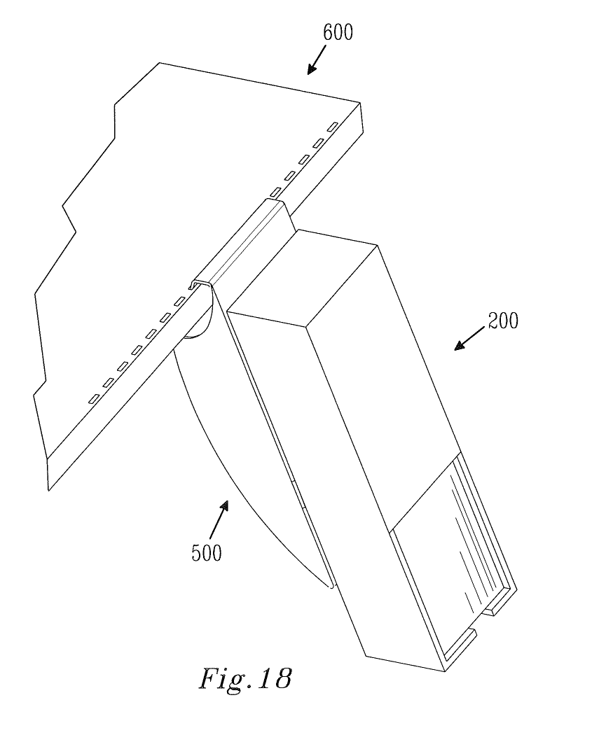

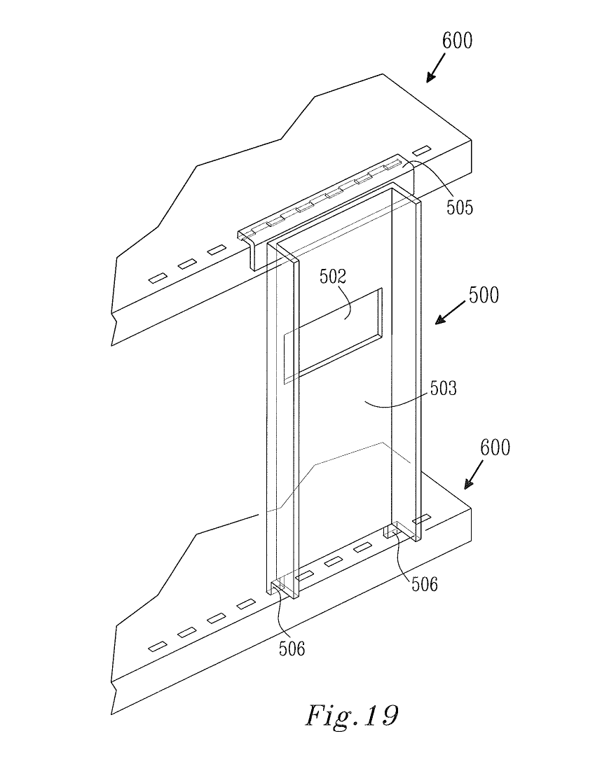

The first support means 502 may comprise a wire, rod, ledge, thread or cut-out extending in the horizontal plane across substantially the entire adaptor 500. Containers 200 are hung via their projections 214 (see FIGS. 18, 20, 22, 24 and 26) on said first support means 502. Such first support means 502 has the advantage that the containers 200 are free to slide horizontally along the adaptor 500, providing flexibility in the display of the containers 200. An adaptor 500 may have a first support means 302 in the form of a cut-out extending substantially completely across the entire adaptor 500 in the horizontal plane, into which the projections 214 on the container 200 can be inserted (see e.g. FIGS. 19, 21, 23 and 25). This is particularly relevant for the containers shown in FIGS. 1 and 5,

The adaptor 500 also comprises at least one second support means 503 for preventing the container 200 from rotating about an axis perpendicular to the two opposing side panels 205, 206 thereof, thus maintaining said at least one container 200 on said adaptor 500. As per the first support means, 502, the second support means 503 may be a wire, rod or thread extending in the horizontal plane, upon which containers 200 may rest. The second support means 503 may extend in the horizontal plane across substantially the entire adaptor 500. The adaptor 500 may therefore comprise a pair of parallel wires, rods or threads extending in the horizontal plane. The second support means 503 may also comprise a projection which extends under the rear panel 202 of each container 200, in the direction of the bottom panel 204 thereof. If the adaptor 500 comprises a shelf in which the first support means 502 has the form of a cut-out extending in the horizontal plane, the lower part of the shelf constitutes the second support means 503. In the embodiments shown in FIGS. 18, 20, 22, 24 and 26, the second support means 503 is arranged to lie under the rear panel 204 of the container. The second support means 503 may optionally engage with at least one protrusion 214 on the container 200, however, it is preferred that the second support means 503 does not prevent the container 200 from sliding down in the direction of the bottom panel 202, but rather its only function is to prevent the container 200 from rotating about an axis perpendicular to the two opposing side panels 205, 206.

Combinations of first 502 and second 503 support means may be chosen by the skilled person. The combination of first 502 and second 502 support members maintains said at least one container 200 on said adaptor 500 such that the panel of the container 200 from which the protrusions 214 extend makes an angle with the horizontal shelf 600.

The adaptor 500 does not comprise means such as a ledge, protrusion, or lip at the lower edge thereof, which is adapted to contact the bottom panel 202 of the container. In other words, the only component of the adaptor 500 which prevents the container 200 from sliding down in the direction of the bottom panel 202 is the first support means 502, and this first support means 502 is not located at the lower front edge of the adaptor 500. In particular, the lack of a ledge, protrusion or lip at the lower front edge of the adaptor 500 means that the last few products in the container 200 are easier to access. The adaptor 500 of the invention is designed so that the bottom panel 202 of the container 200 is not obstructed when supported on said adaptor 500.

The adaptor 500 according to the invention may simply rest upon the substantially horizontal shelf 600. However, to improve fastening of the adaptor 500 to the shelf 600, the adaptor 500 may further comprise at least one engaging means 505, 506 which is adapted to engage with said shelf 600. Engagement of the engaging means 505, 506 with the shelf 600 may occur via the recesses, holes, lips, ledges or other surface irregularities which are present in many shelves used in commercial settings (see the embodiments of FIGS. 18 and 19).

In one embodiment, shown in more detail in FIGS. 16, 17 and 18, first engaging means 505 are adapted to engage with the upper surface of said shelf 600 while second engaging means 506 are adapted to engage with the lower surface of said shelf 600, and both first 505 and second 506 engaging means are located at the same end of the adaptor 500. The adaptor 500 shown in FIGS. 16, 17 and 18 has first engaging means 505 in the form of “tags” which engage with holes in the upper surface of the horizontal shelf 600, and second engaging means 506 in the form of support arms which contact the lower surface of the shelf 600. The invention should not be considered as limited to the engaging means illustrated in FIGS. 16, 17 and 18. Alternative engaging means may comprise hooks, wires, loops etc. which are designed to engage with features on the horizontal shelf 600. The skilled person will be able to design suitable engaging means 505, 506, depending on the features present on the shelf 600.

The first support 502 means of the embodiment of FIGS. 16, 17 and 18 takes the form of a ledge, while the second support means 503 comprises the lower portion of the adaptor 500. The projection 214 (particularly flap 214′) engages with the ledge, and the container 200 is supported on the adaptor 500. The first 502 and second 503 support means of the embodiment of FIGS. 16, 17 and 18 are arranged so that the container 200 is supported so that it extends at least partially beyond the front edge of the horizontal shelf 600, preferably completely beyond the front edge of the horizontal shelf 600, so as to not take up space on the shelf itself. In that the container 200 extends beyond the horizontal shelf 600, it becomes more prominent in a retail environment.

In the embodiments of FIGS. 16-18 and 23-26, the angle between the panel of the container 200 from which the protrusions 214 extend and the horizontal shelf 600 is between 10 and 80°, preferably between 20 and 70°, more preferably between 30 and 60°. The second 503 support means is thus typically located below and in front of the first support means 502, as seen from the direction of the bottom panel of a container 200. Suitable angles can be selected as per the support system 300 discussed above. Alternatively, the angle between the panel of the container 200 from which the protrusions 214 extend and the horizontal shelf 600 is substantially 90°, as shown in the embodiments of FIGS. 19-22. “Substantially 90°” in this context is taken to mean an angle above 80°, approaching the fully vertical 90°. In this case, the dispensing opening 210 may have to be adjusted so that products do not readily fall out of the container 200. For example, as shown in FIGS. 19-22, the dispensing opening 210 does not extend to both first and second side panels 205, 206 across its entire height H1.

The adaptor 500 may adopt a range of angles to the horizontal. To this end, a single component of the adaptor 500 may be instead comprised of two or more components which are hinged or similarly adjustable with respect to one another. For example, in the embodiment shown in FIGS. 16, 17 and 18, the second engaging means 506 in the form of support arms which contact the lower surface of the shelf 600 may be extensible, thus allowing the adaptor 500 to be adjusted. Adjustment of the angle between the panel of the container 200 from which the protrusions 214 extend and the horizontal shelf 600 may be continuous (e.g. by using a screw-thread or a component which slides in a groove formed in another component) or step-wise (e.g. by using serrated components).

The adaptor 500 may extend between two adjacent horizontal shelves 600, and engage with them both. The adaptor 500 may therefore hold the container 200 in a substantially vertical configuration, as per the embodiment shown in FIGS. 19-22. This embodiment provides greater stability for the adaptor 500.

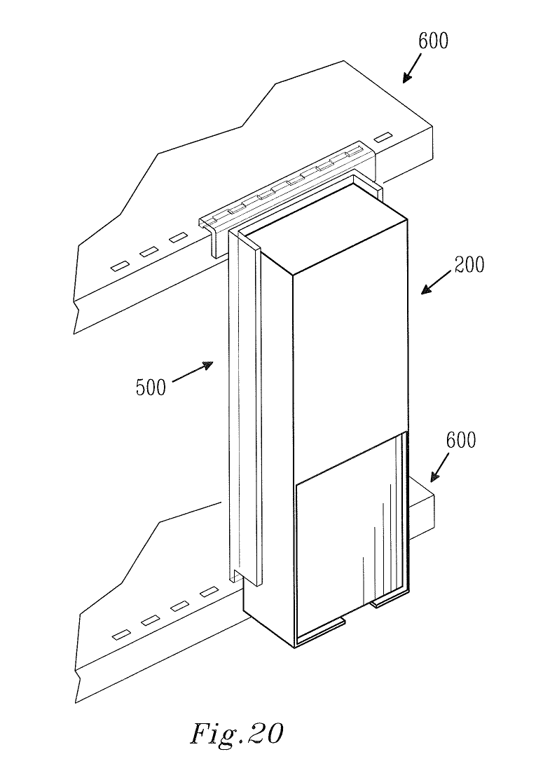

The adaptor 500 illustrated in FIG. 19, is constructed from plastic, and comprises engaging means 505, 506 which are adapted to engage with the shelf 600. In this case, the engaging means 505, 506 take the form of tags at each end of the adaptor 500, which are capable of being inserted into holes or recesses in each shelf 600. The adaptor of FIG. 19 comprises a first support means 502 in the form of a cut-out, into which the projection(s) 214 of the container 200 can be inserted (FIG. 20). The second support means 503 of the adaptor in FIG. 19 is comprised by the lower portion of the adaptor 500.

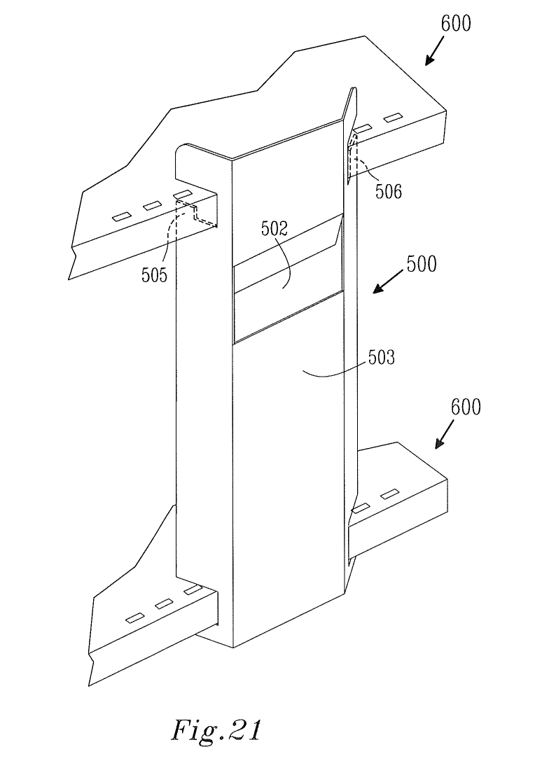

The adaptor 500 illustrated in FIG. 21, is constructed from cardboard, and comprises engaging means 505, 506 which are adapted to engage with the shelf 600. In this case, the engaging means 505, 506 take the form of hooks, which engage with the underside of the upper shelf 600. The adaptor of FIG. 21 comprises a first support means 502 in the form of a cut-out, into which the projection(s) 214 of the container 200 can be inserted. The second support means 503 of the adaptor in FIG. 19 is comprised by the lower portion of the adaptor 500.

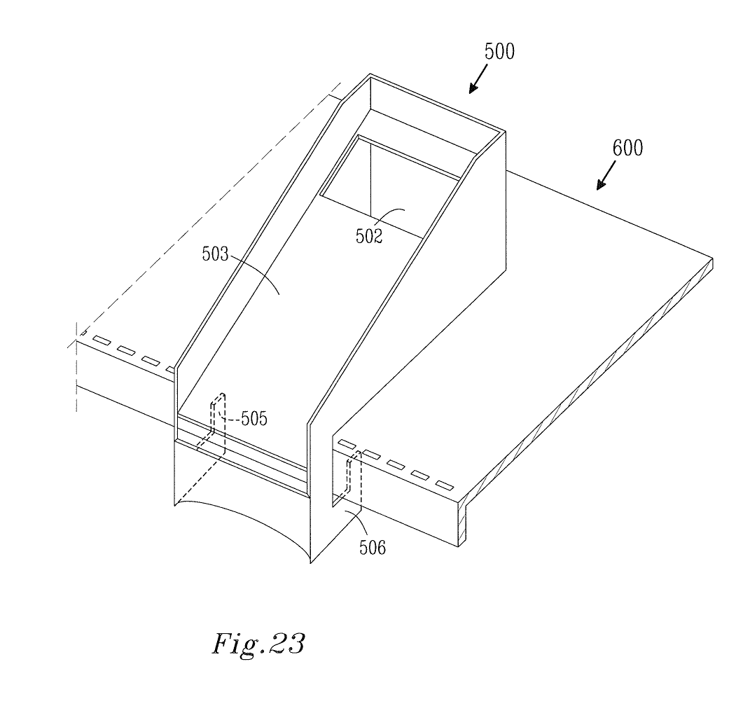

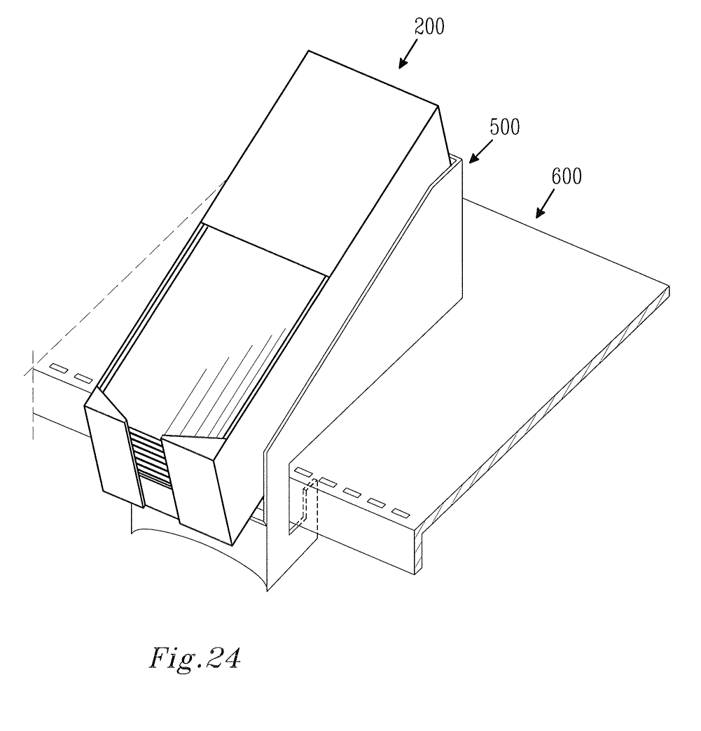

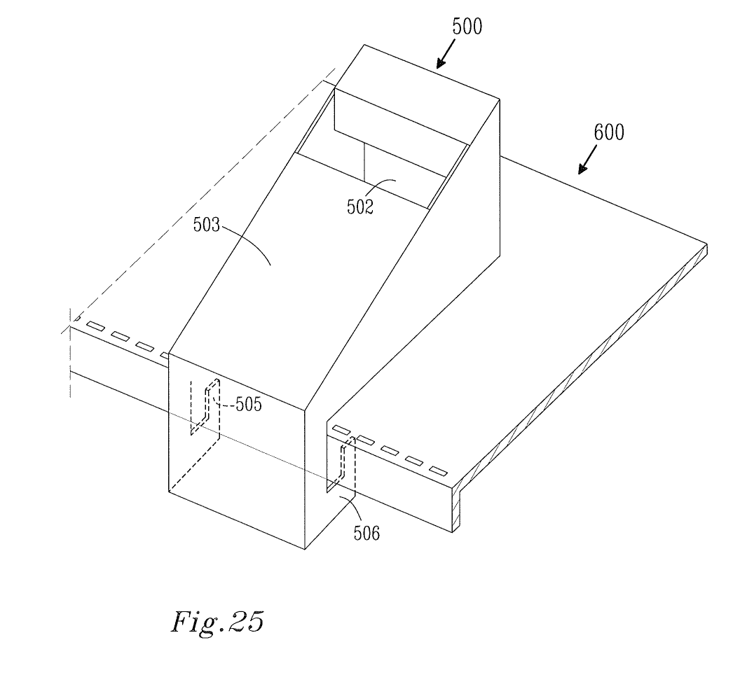

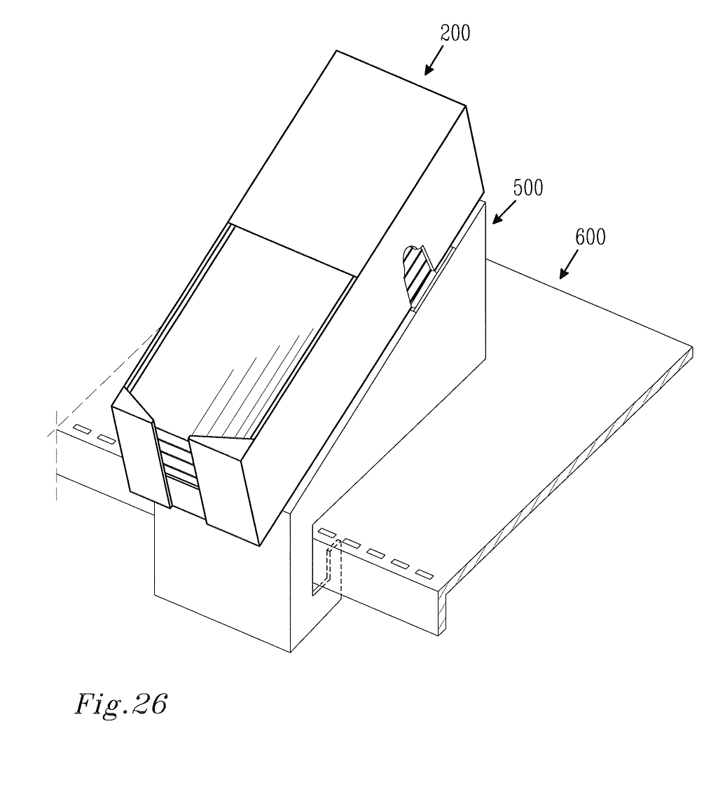

The adaptors 500 embodied in FIGS. 23-26 are designed to sit at least partially on top of the horizontal shelf 600. The adaptors are wedge-shaped, with engaging means 505, 506 which is adapted to engage with said shelf 600. In the illustrated embodiments, the engaging means 505, 506 comprise a pair of hooks which curve around the front edge of the horizontal shelf and engage with the lower edge thereof. The adaptors 500 embodied in FIGS. 23-26 comprise a first support means 502 in the form of a cut-out, into which the projection(s) 214 of the container 200 can be inserted (see FIGS. 24 and 26). The second support means 503 of the adaptor in FIGS. 23-26 is comprised by the lower portion of the adaptor 500. The main difference between the embodiments of FIGS. 23 and 25 is that the embodiment of FIG. 23 comprises walls which surround the container 200, defining its place on the adaptor 500. The embodiment of FIG. 25 does not have walls which surround the container 200, making this embodiment more flexible in terms of the placement, and dimensions of the containers 200.

### System

The invention also provides the combination (system 100) of at least one container 200 as described herein, and a support system 300 as described herein, as shown in FIGS. 8 and 9. The at least one container 200 is supported on said support system 300 at an angle inclined to the horizontal, by means of said at least one protrusion 214. Seen from the front panel 203, the container leans backwards, with the front panel 203 located above said bottom panel 202, with the two side panels 205, 206 vertical. The panel of the container 200 from which the protrusions 214 extend makes an angle with the horizontal plane of between 10 and 80°, preferably between 20 and 70°, more preferably between 30 and 60°.

The system 100 may comprise at least two, such as at least three, at least five or at least ten, containers 200 arranged horizontally in rows with the side panel 205 of one container facing the opposite side panel 206 of the neighbouring container. Additionally or alternatively, the system 100 may comprise at least two, such as at least three, at least five, or at least ten, containers 200 arranged vertically in a staggered column with the rear panel 204 of one container overlying the front panel 203 of an underlying container. In this case, the dispensing opening 210 in the front panel 203 of an underlying container occupies the region of said front panel 203 which is not covered by rear panel 204 of the overlying container, as shown in FIG. 9, so that products can be easily dispensed.

The invention also provides a system 100 comprising at least one container 200 as described herein, and an adaptor 500 as described herein (see FIGS. 18, 20, 22, 24 and 26).

Although the invention has been described with reference to a number of embodiments and Figures, it should not be understood as being limited thereby. Features from embodiments may be combined at will. The scope of the invention is rather determined by the enclosed claims.

1-29. (canceled)

30. A container (200) for the storage, transport, display and dispensing of products, said container (200) comprising:
opposing top (201) and bottom panels (202) separated by a height H;
at least one sidewall (203, 204, 205, 206) extending between said top (201) and bottom panels (202),
a dispensing opening (210) located in a portion of a front panel (203) in the region adjacent to said bottom panel (202), and extending into a portion of said bottom panel (202), said dispensing opening (210) having a height H1 in the front panel (203) which is less than the height H of the container (200),
characterised in that
the container (200) comprises at least one protrusion (214) for selective releasable cooperation with one of a container support system (300), an adaptor (500) or an identical container (200), said at least one protrusion (214) being integrally formed with at least one of said top panel (201), bottom panel (202) or at least one sidewall (203, 204, 205, 206);
such that, in a first configuration A, said at least one protrusion (214) is accommodated within said at least one of said top panel (201), bottom panel (202) or at least one sidewall (203, 204, 205, 206);
and, in a second configuration B, said at least one protrusion (214) extends from said at least one sidewall (203, 204, 205, 206) in a direction opposite to said dispensing opening (210)
and that—in the front panel (203) in which it is located—the dispensing opening (210) extends along the entire edge defined by the front panel (203) and the bottom panel (202) of the container (200).

31. The container (200) according to claim 30, wherein the protrusions (214) are arranged so as to form a portion of one or more sidewalls (203, 204, 205, 206) of the container (200) in the first configuration A and folded out from said sidewalls (203, 204, 205, 206) in the second configuration B.

32. The container (200) according to claim 30, wherein the dispensing opening (210) has an extension H1 in the height H direction which is less than 50%, preferably less than 30% of the total height H of the container (200).

33. The container (200) according to claim 30, wherein the height H of the container (200) is at least 1.5 times, preferably at least 2 times, more preferably at least 3 times, the width W and/or the depth D of the container (200).

34. The container (200) according to claim 30, said container (200) being cuboid and having sidewalls (203, 204, 205, 206) comprising opposing rectangular front (203) and rear panels (204) separated by a depth D, and first (205) and second (206) opposing rectangular side panels separated by a width W.

35. The container (200) according to claim 34, wherein the dispensing opening (210) is located in said front panel (203), and in the first configuration A, the at least one protrusion (214) extends from the rear panel (204).

36. The container (200) according to claim 35, wherein the front panel (203) of the container (200) additionally comprises at least one support opening (213), such that—when two containers (200) are stacked upon each other in the second configuration B—the at least one protrusion (214) extending from the rear panel (204) of one container (200) engages with the support opening (213) on the front panel (203) of the other container (200).

37. The container (200) according to claim 34, wherein the rear panel (204) of the container (200) additionally comprises a viewing opening (215) in the rear panel (204).

38. The container (200) according to claim 34, wherein the at least one protrusion (214) is integrally formed with the rear panel (204).

39. The container (200) according to claim 30, wherein the protrusion (214) comprises a flap (214′) which opens in the direction of the top panel (201).

40. A blank (400) for forming a container (200) according to claim 30.

41. The blank (400) according to claim 40 for forming a container (200), said blank comprising:
a first rectangular panel (403) having opposing side edges (403A, 403B) and opposing end edges (403C, 403D), wherein each of said opposing side edges (403A, 403B) has a length (H) corresponding to the height (H) of the container (200) and each of said opposing end edges (403C, 403D) has a length (W) corresponding to the width W of the container (200);
second (405) and third (406) rectangular panels, each having opposing side edges (405A, 405B, 406A, 406B) and opposing end edges (405C, 405D, 406C, 406D), wherein each of said opposing side edges (405A, 405B, 406A, 406B) has a length (H) corresponding to the height (H) of the container (200) and each of said opposing end edges has a length (D) corresponding to the depth (D) of the container (200);
a fourth rectangular panel (404) having opposing side edges (404A, 404B) and opposing end edges (404C, 404D), wherein each of said opposing side edges (404A, 404B) has a length (H) corresponding to the height (H) of the container (200) and each of said opposing end edges (404C, 404D) has a length (W) corresponding to the width W of the container (200);
flaps (430, 431, 432, 433, 434, 435, 436, 437) extending from the opposing end edges (403C, 403D, 405C, 405D, 406C, 406D, 404C, 404D) of at least three of said rectangular panels (403, 404, 405, 406), said flaps being arranged so as to constitute top (201) and bottom (202) panels of said container (200);
wherein the second and third rectangular panels (405, 406) are located on either side of the first rectangular panel (403) such that each of said opposing side edges (403A, 403B) of the first rectangular panel (403) is joined to one opposing side edge (405A, 406B) of the second and third rectangular panels (405, 406) and separated therefrom by score lines (421, 422), and;
the fourth rectangular panel (404) is located adjacent the second rectangular panel (405), such that the opposing side edge (404A) of the fourth rectangular panel (404) is joined to the other opposing side edge (405B) of the second rectangular panel (405) and separated therefrom by score line (422);
and wherein the opposing side edge (404B) of the fourth rectangular panel (404) which is not joined to the second rectangular panel (405); or the opposing side edge (406A) of the third rectangular panel (406), comprises a flap (438) for connecting the opposing side edge (406A) of the third rectangular panel (406) to the opposing side edge (404B) of the fourth rectangular panel (404),
characterised in that
the fourth rectangular panel (404) comprises means (410) for forming a dispensing opening (210), adjacent to one end edge (404C) thereof, and that;
at least one of the first (403), second (405), third (406) or fourth (406) rectangular panels comprises means (414) for forming at least one protrusion (214).

42. The blank (400) according to claim 41, wherein the means (410) for forming the dispensing opening (210) has an extension H1 in the height H direction which is less than 50%, preferably less than 30% of the total height H of the container (200).

43. The blank (400) according to claim 41, wherein the fourth panel (404) additionally comprises means (413) for forming a support opening (213).

44. A blank (400) according to claim 41, wherein the first panel (403) additionally comprises means (415) for forming a viewing opening (215).

45. A support system (300) for a container (200) according to claim 40, said support system (300) comprising at least one frame (301), said at least one frame (301) comprising: at least one first support means (302) which is adapted to engage with at least one protrusion (214) on the container (200), thus preventing the container (200) from sliding down in the direction of the bottom panel (202) thereof, and at least one second support means (303) for preventing the container (200) from rotating about an axis perpendicular to the two opposing side panels (205, 206) thereof, thus maintaining said at least one container (200) on said support system (300) such that the panel of the container (200) from which the protrusions (214) extend makes an angle with the horizontal plane of between 10 and 80°,
wherein the frames (301) do not comprise means such as a ledge, protrusion, or lip at the lower edge thereof, which is adapted to contact the bottom panel (202) of the container
characterised in that
the first support means (302) comprises a wire, rod, ledge, thread or cut-out extending in the horizontal plane across substantially the entire frame (301).

46. The support system (300) according to claim 45, wherein the at least one second support means (303) is selected from the group consisting of a wire, rod, thread, ledge or panel (303) which optionally engages with at least one protrusion (214) on the container (200).

47. A support system (300) according to claim 45, for a container (200) in which the protrusion (214) comprises a flap (214′) which opens in the direction of the top panel (202) of the container (200);
said support system (300) comprising at least one shelf (320) having at least a front member (321) and a rear member (322), said front member (321) arranged to lie between the rear member (322) and the container (200) in use,
wherein the front member (321) and rear member (322) together define a space (324) which has a maximum extension which is less than the length of said flap (214′),
wherein said space (324) and an opening (323) are arranged with respect to each other in the plane of the shelf (320) such that—when mounting a container (200) in said shelf (320)—the flap (214′) engages in the space (324) between the front (321) and rear (322) members.

48. The support system (300) according to claim 47, wherein the rear member (322) comprises an opening (323) for receiving the distal end of the flap (214′);
said opening (323) in the rear member (322) being arranged such that—when removing a container (200) from said shelf (320)—the container (200) is displaced in the plane of the shelf, such that the flap (214′) can be inverted in said opening (323), allowing said container (200) to be withdrawn.

49. The support system (300) according to claim 47, wherein the shelf (320) is made of one single piece of material which is bent to form the front member (321) and the rear member (322), respectively.

50. An adaptor (500) for adapting at least one substantially horizontal shelf (600) so as to be able to support a container (200) according to claim 30 at an angle to the horizontal shelf (600);
said adaptor (500) comprising;
at least one first support means (502) which is adapted to engage with said at least one protrusion (214) on the container (200), thus preventing the container (200) from sliding down in the direction of the bottom panel (202) thereof,
and at least one second support means (503) for preventing the container (200) from rotating about an axis perpendicular to the two opposing side panels (205, 206) thereof,
thus maintaining said at least one container (200) on said adaptor (500) such that the panel of the container (200) from which the protrusions (214) extend makes an angle with the horizontal shelf (600),
characterised in that
the adaptor (500) does not comprise means such as a ledge, protrusion, or lip at the lower edge thereof, which is adapted to contact the bottom panel (202) of the container. wherein said adaptor (500) further comprises at least one engaging means (505, 506) which is adapted to engage with said shelf (600),
wherein first engaging means (505) are adapted to engage with the upper surface of said shelf (600) and second engaging means (506) are adapted to engage with the lower surface of said shelf (600), and wherein both first (505) and second (506) engaging means are located at the same end of the adaptor (500);

51. The adaptor (500) according to claim 50, wherein the angle between the panel of the container (200) from which the protrusions (214) extend and the horizontal shelf (600) is between 10 and 80°.

52. The adaptor (500) according to claim 50, wherein the angle between the panel of the container (200) from which the protrusions (214) extend and the horizontal shelf (600) is substantially 90°.

53. The adaptor (500) according to claim 50, wherein the first (502) and second (503) support means are arranged so that said container (200) is supported so that it extends at least partially beyond the front edge of the horizontal shelf (600).

54. A system (100) comprising:
a. at least one container (200) according to claim 30, and
b. a support system (300);
said at least one container (200) being supported on said support system (300) at an angle, by means of said at least one protrusion (214), with the front panel (203) located above said bottom panel (202), such that the two side panels (205, 206) are vertical, and the panel of the container (200) from which the protrusions (214) extend makes an angle with the horizontal plane of between 10 and 80°.

55. A system (100) comprising:
a. at least one container (200) according to claim 30, and
b. an adaptor (500);
said at least one container (200) being supported on said adaptor (500) at an angle, by means of said at least one protrusion (214), with the front panel (203) located above said bottom panel (202), such that the two side panels (205, 206) are vertical, and the panel of the container (200) from which the protrusions (214) extend makes an angle with the horizontal plane.
